(19) United States
(12) Patent Application Publication
(10) Pub. No.: US 2018/0212490 A1
(43) Pub. Date: Jul. 26, 2018

(54) ROTATING ELECTROMAGNETIC DEVICES

(71) Applicant: HERON ENERGY PTE. LTD, Singapore (SG)

(72) Inventors: Ante GUINA, Surfers Paradise (AU); David SERCOMBE, Arundel (AU); Rene FUGER, Singapore (SG); John Alan KELLS, Singapore (SG); Arkadiy MATSEKH, Singapore (SG)

(73) Assignee: HERON ENERGY PTE. LTD, Singapore (SG)

(21) Appl. No.: 15/744,722

(22) PCT Filed: Jul. 13, 2016
(86) PCT No.: PCT/AU2016/050610

§ 371 Date: Jan. 12, 2018

(30) Foreign Application Priority Data
Jul. 13, 2015 (AU) 2015902759
Sep. 18, 2015 (AU) 2015903808
Oct. 9, 2015 (AU) 2015904119
Oct. 13, 2015 (AU) 2015904164

(51) Int. Cl. H02K 3/47; H02K 49/10; H02K 55/00; H02K 99/00

(52) U.S. Cl. CPC H02K 3/47; H02K 99/00; H02K 55/00; H02K 49/102

(57) ABSTRACT

An electromagnetic device is presented. The device includes a stator, a gap comprising multiple gap regions, and a rotor arranged in the gap to move relative to the stator. One of the stator and the rotor comprises a conductor array having one or more conductors each configured to carry current in a respective current flow direction. The other of the stator and the rotor comprises a flux directing assembly having multiple flux directing sections, each arranged adjacent to at least one other flux directing section and each configured to facilitate a circulating magnetic flux path about the respective flux directing section. Each pair of adjacent flux directing sections are arranged about a common gap region of the multiple gap regions and configured to direct at least part of the respective circulating magnetic flux paths across the common gap region in a substantially similar flux direction substantially perpendicular to the current flow direction.

### TECHNICAL FIELD

The present invention relates to electromagnetic devices using rotating elements in a magnetic field, in particular to the variations of current carrying bars/windings placed in a magnetic field and the application of electrical current through these current carrying bars/windings.

### BACKGROUND ART

It is a well understood aspect of electrometric theory that as current passes through a simple bar conductor, it induces a magnetic field perpendicular to the direction of current flow. As a result of the induced magnetic field, each of the moving charges comprising the current, experiences a force. The force exerted on each of the moving charges generates torque. It is this principle that underpins devices such as electric motors and generators.

Most typical DC motors consist of three main components namely a stator, armature/rotor and commutator. The stator typically provides a magnetic field which interacts with the field induced in the armature to create motion. The commutator acts to reverse the current flowing in the armature every half revolution thereby reversing the field in the armature to maintain its rotation within the field in the one direction. A DC motor in its simplest form can be described by the following three relationships:

eₐ=KΦω

V=eₐ+Rₐiₐ

T=KΦiₐ

Where eₐ is the back emf, V the voltage applied to the motor, T the torque, K the motor constant, Φ the magnetic flux, ω the rotational speed of the motor, _{Ra} the armature resistance and iₐ the armature current.

The magnetic field in a typical motor is stationary (on the stator) and is created by permanent magnets or by coils. As current is applied to the armature/rotor, the force on each conductor in the armature is given by F=iₐ×B×1. Back emf is generated due to a relative rate of flux change as a result of the conductors within the armature rotating through the stationary field. The armature voltage loop therefore contains the back emf plus the resistive losses in the windings. Thus, speed control of the DC motor is primarily through the voltage V applied to the armature while torque scales with the product of magnetic flux and current.

Thus, in order to maximise torque in a DC motor, one would presume that it is simply a matter of increasing either the magnetic field or the current supplied. In practice, however, there are limitations. For instance, the size of the magnetic field which can be generated via permanent magnets is limited by a number of factors. In order to produce a significantly large field from a permanent magnet, the physical size of the magnet is relatively large (e.g. a 230 mm N35 magnet is capable of producing a field of a few Kilogauss (kG)). Significantly, larger fields can be produced utilising a plurality of magnets, the size and number of magnets again adds to the overall size and weight of the system. Both size and weight of the motor are critical design considerations in applications such as electric propulsion systems. Generation of larger magnetic fields is possible utilising standard wire coils but the size, weight and heating effects make the use of standard coils impractical.

Another factor which has an effect on torque that needs consideration is the production of drag caused by eddy currents created within the armature/rotor. Eddy currents occur where there is a temporal variation in the magnetic field, a change in the magnetic field through a conductor or change due to the relative motion of a source of magnetic field and a conducting material. The eddy currents induce magnetic fields that oppose the change of the original magnetic field per Lenz's law, causing repulsive or drag forces between the conductor and the magnet. The power loss (P) caused by eddy currents for the case of a simple conductor assuming a uniform a material and field, and neglecting skin effect can be calculated by:

$$P = \frac{{π}^{2} {B}_{P}^{2} {d}^{2} {f}^{2}}{12 ρ D}$$

where Bₚ is peak flux density, d—thickness or diameter of the wire, ρ—resistivity, σ—electrical conductivity, μ magnetic permeability, f frequency (change in field) and penetration depth (D).

As can be seen from the above equation, as the magnetic field increases the size and effects of eddy currents increase i.e. the higher the magnetic field, the greater the drag produced as a result of eddy currents. In addition to the field strength, the resistivity of and thickness of the conductive elements in the armature are also a factor. Selection of the material of the conductive elements in the armature can greatly affect the amount of current that can be applied to the armature.

These basic properties and functions are the focus of continuing developments in the search for improved devices having better efficiencies.

Reference to any prior art in this specification is not, and should not be taken as an acknowledgement or any form of suggestion that the prior art forms part of the common general knowledge.

### SUMMARY OF INVENTION

Aspects of the present invention are directed to electromagnetic devices, such as electromagnetic motors or generators, which may at least partially overcome at least one of the abovementioned disadvantages or provide the consumer with a useful or commercial choice.

According to an aspect of the present invention, an electromagnetic device is provided. The electromagnetic device comprises: a stator; a gap comprising multiple gap regions; and a rotor arranged in the gap to move relative to the stator. One of the stator and the rotor comprises a conductor array having one or more conductors each configured to carry current in a respective current flow direction, the other of the stator and the rotor comprises a flux directing assembly having multiple flux directing sections, each arranged adjacent to at least one other flux directing section and each configured to facilitate a circulating magnetic flux path about the respective flux directing section. Each pair of adjacent flux directing sections are arranged about a common gap region of the multiple gap regions and configured to direct at least part of the respective circulating magnetic flux paths across the common gap region in a substantially similar flux direction substantially perpendicular to the current flow direction.

The adjacent flux directing sections are further configured to redirect the respective circulating magnetic flux paths from (or to) other gap regions of the multiple gap regions to (or from) the common gap region.

The adjacent flux directing sections include a common working element configured to direct magnetic flux into and out of the common gap region.

Each of the adjacent flux directing sections include a redirecting element configured to receive (or forward) the magnetic flux from (or to) the common gap region and redirect the magnetic flux to (or from) a respective one of the other gap regions.

The strength of the magnetic flux directed by the common working element may be reinforced compared to strength of the magnetic flux directed by the redirecting element.

In some embodiments, the common working element includes two electromagnetic coils placed on opposite sides of the common gap region.

In some embodiments, the redirecting element includes a single electromagnetic coil configured to direct the magnetic flux through the single electromagnetic coil in a direction tangential to the rotation of the rotor. In other embodiments, the redirecting element includes two electromagnetic coils, each placed on an opposite side of the gap. In yet other embodiments, the redirecting element includes one or more additional electromagnetic coils configured to direct the magnetic flux to (or from) the single electromagnetic coil.

The opposite sides of the gap or the common gap region represent an inner portion and an outer portion of the flux directing assembly. In some embodiments, the inner portion may include a flux guide and the outer portion may include one or more electromagnetic coils. In other embodiments, the inner portion may include one or more electromagnetic coils and the outer portion may include a flux guide.

The electromagnetic coil(s) may include one or more racetrack coils.

In some embodiments, the common working element includes one or more permanent magnets placed on each of opposite sides of the common gap region and oriented in a substantially radial direction. In such embodiments, the redirecting element may include one or more permanent magnets placed on each of the opposite sides of the common gap region and oriented in a substantially non-radial direction.

In some embodiments, the common working element may include a flux guide on a first side of the common gap region and one or more permanent magnets placed on a second, opposite side of the common gap region and oriented in a substantially radial direction. In these embodiments, the redirecting element may include an additional flux guide on the first side of the common gap region and one or more additional permanent magnets placed on the second, opposite side of the common gap region and oriented in a substantially non-radial direction.

The permanent magnets of the working and/or redirecting elements may be oriented to form one or more Halbach arrays or partial Halbach arrays.

The respective circulating magnetic flux paths of the adjacent flux directing sections circulate in opposite directions. For example, the magnetic flux path of one of the adjacent flux directing sections may circulate in a clockwise direction and the magnetic flux path of the other of the adjacent flux directing sections may circulate in an anticlockwise direction.

The number of the circulating magnetic flux paths may equal the number of magnetic flux traversals across the gap. Further, the number of flux directing sections may equal the number of gap regions.

Also disclosed is a magnetic gearbox that includes a rotating crown and pinion rotors. The crown and pinions may each include a magnetic array. In an arrangement, the magnetic array may be sequentially radially magnetised. For example, the magnetic array may form one or more Halbach magnetic array or partial array.

### BRIEF DESCRIPTION OF THE DRAWINGS

FIG. 1 is an isometric view of a Star Toroidal motor/generator with the outer inner toroidal sectors comprised of a smaller number of constituent racetrack coils.

FIG. 2 is an end view of the embodiment of FIG. 1 showing the reduced number of constituent racetrack coils.

FIG. 3 is a magnetic field plot of the device shown in FIG. 2.

FIG. 4 is a variation of the embodiment of FIG. 1 where interstitial secondary coils have been positioned between the primary element constituent racetrack coils of the inner and outer coil assemblies.

FIG. 5 is an end view of the device of FIG. 4 clearly showing the additional secondary coils in between the main racetrack coils of the assembly.

FIG. 6 is a magnetic field plot of the embodiment shown in FIG. 4 showing the more even distribution of the magnetic field through the toroidal windings.

FIG. 7 is a Star Toroidal motor/generator variation where the interstitial coils are the same size as the primary toroidal coils.

FIG. 8 is an end view of the device shown in FIG. 7.

FIG. 9 is an embodiment similar to that shown in FIG. 1 but featuring an additional racetrack coil in between each external toroid to further direct the magnetic field perpendicularly through the working gap.

FIG. 10 is an end view of the embodiment of FIG. 9 with the additional flux guiding coils.

FIG. 11 is the embodiment shown in FIG. 9 but with an additional inter-toroid flux guiding coils used on the inner toroid assembly as well.

FIG. 12 is an end view of the embodiment of FIG. 11 with the additional flux guiding coils.

FIG. 13 is a further variation on the device of FIG. 9 where an additional flux guiding winding has been added inside the inner radius of the outer toroid in order to better direct the toroidal magnetic field through the working region.

FIG. 14 is an end view of the embodiment of FIG. 13 with the additional flux guiding coils.

FIG. 15 is a star toroidal motor/generator where the internal toroids have been replaced with steel flux guides in the shape of sectors of a cylinder.

FIG. 16 is an end view of the device of FIG. 15 showing the positioning and shape of the internal steel flux guides.

FIG. 17 is a star toroidal embodiment wherein the inner steel/ferromagnetic flux guide consists of a cylinder of material that rotates with the rotor windings. The cylinder can be laminated to reduce eddy current/parasitic loss.

FIG. 18 is a variation of the star toroidal device with internal steel flux guides where the external toroidal sectors include redirecting interstitial coils to even out the distribution of the flux through the thickness of the toroid.

FIG. 19 shows the motor/generator of FIG. 18 with the additional interstitial coils in the outer toroidal sectors.

FIG. 20 is a further variation where the middle section of the outer toroids is composed of individual racetrack coils. Each end of the arcs that make up to the toroidal sectors is wound continuously on a former as a ‘sealed’ element. The very edge of this continuously formed winding is radiussed to match the radius of the rotor windings.

FIG. 21 shows the device of FIG. 20 showing the sealed and radiussed windings at either end of the outer toroidal arcs.

FIG. 22 is an embodiment where an additional steel flux guide has been added to the inside of the outer toroidal windings in order to direct the magnetic field substantially towards to the rotor windings. A section of the toroidal windings has been hidden for clarity.

FIG. 23 is a sectional end view of the embodiment of FIG. 22 showing shape and positioning of the internal steel bulks.

FIG. 24 is a star toroidal motor/generator embodiment with internal ‘sock’ style flux guides that follow the contour of the inner part of the outer toroidal windings.

FIG. 25 is a sectional end view of the embodiment of FIG. 24.

FIG. 26 is a star toroidal motor/generator embodiment with external ‘sock’ style flux guides that follow the contour of the external part of the outer toroidal windings.

FIG. 27 is an end view of the embodiment of FIG. 26.

FIG. 28 is a magnetic gearbox shown with 6 pinion rotors. The magnetisation of the crown and pinion elements produces a complementary set of internal (crown) and external (pinion) Halbach cylinders.

FIG. 29 is an end view of the device of FIG. 28.

FIG. 30 is a detailed view of the magnetic gearbox of FIG. 28. The repeating patterns of directions of magnetisation to create the Halbach cylinders are indicated.

FIG. 31 shows a hybrid style magnetic gear box where the magnetic elements can interlock like shaped teeth.

FIG. 32 is an end view of the device of FIG. 31.

FIG. 33 is a detailed end view of the interlocking magnetic gearbox.

FIG. 34 is a half sectional view of a multi-layer magnetic gearbox. In previously shown embodiments the poles of the device have effectively been magnetised in the radial direction. In this embodiment the magnetic poles predominately act in the axial direction.

FIG. 35 is an end view of the device shown in FIG. 34 showing the relative axial magnetisation of the crown and pinion layers.

FIG. 36 shows the basic element of an axial style magnetic gearbox showing a crown gear and a set of pinion rotors. The individual magnets are magnetised such that an axial Halbach array is created. In the above embodiment sectors of magnetic material are used rather than the rounded rectangular elements of FIG. 34.

FIG. 37 is an end view of the axial Halbach magnetic gearbox shown in FIG. 36.

FIG. 38 is a detailed end view of the magnetic gearbox of showing the direction of polarisation on the individual magnet elements to create the axial Halbach array. The cross indicates a magnetisation vector coming out of the page and the circles represent a vector going into the page.

FIG. 39 shows a variation of the Star Toroidal device featuring a solid internal steel flux guide.

FIG. 40 shows a Star Toroidal embodiment where the racetrack coils near the working gap have been subdivided into several layers of coils.

FIG. 41 shows an individual layered racetrack coil assembly isolated from the embodiment of FIG. 41. The layered coils help to spread the peak field of the coils more evenly.

FIG. 42 shows an embodiment in which the coils sets near to the working region/rotor are layered in different manner to that of FIG. 40.

FIG. 43 shows an individual layered racetrack coil assembly isolated from the embodiment of FIG. 42. The layered coils help to spread the peak field of the coils more evenly.

FIG. 44 shows an end view of the embodiment of showing the novel layering of the toroidal sectors coils near the working region/gap with the non-layered coils having fewer total turns than the layer coils in order to better distribute the field.

FIG. 45 shows an electromagnetic device according to one aspect of the present disclosure.

FIG. 46A shows an end view of an example flux directing assembly of the electromagnetic device of FIG. 45. The end view shows the arrangement of the working coils and the flux redirecting coils in between.

FIG. 46C shows the flux directing assembly of FIG. 46A illustrating multiple flux directing sections of the flux directing assembly according to some embodiments of the present disclosure.

FIG. 46B shows the flux directing assembly of FIG. 46A facilitating a circulating flux path in each of the flux directing sections.

FIG. 47 shows an end view of the electromagnetic device illustrated in FIG. 45.

FIG. 48 shows a magnetic field plot of the flux directing assembly shown in FIGS. 45-47.

FIG. 49 shows a version of the electromagnetic device that features multiple redirecting coils that guide the magnetic flux between the working coils.

FIG. 50A shows an end view of the device of FIG. 49. In this embodiment the inner coil array has been replaced by a set of steel/ferromagnetic flux guides.

FIG. 50B shows an end view of the flux directing assembly of FIG. 50A and indicates multiple flux-directing sections and circulating flux paths of the electromagnetic device of FIG. 49.

FIG. 51 shows another embodiment of the electromagnetic device shown in FIG. 49. In this variation the segmented steel flux guides have been replaced with a cylinder of laminated steel that can be stationary or can alternatively spin with the current carrying rotor windings.

FIG. 52 shows an end view of the device illustrated in FIG. 51.

FIG. 53 shows a further variation on the electromagnetic device that features inner and outer flux directing coil sets with additional redirecting coils to direct and strengthen the magnetic field.

FIG. 54 shows an end view of the flux directing assembly of the device of FIG. 53.

FIG. 55A is an end view of the electromagnetic device of FIG. 53.

FIG. 55B shows an end view of the flux directing assembly FIG. 55A and indicates multiple flux-directing sections and circulating flux paths according to some embodiments of the present disclosure.

FIG. 56 is a magnetic field plot of the device of FIG. 53.

FIG. 57 shows a multi-rotor geared toroidal device with one sector of toroidal windings removed and showing additional coils/windings that are located in between the rotor assemblies. These additional superconducting windings help reduce and redistribute the peak magnetic field on the main toroidal superconducting windings increasing the power of the device or allowing for the more efficient use of superconducting wire.

FIG. 58 is a sectional view of the geared toroidal device of FIG. 57 showing the additional windings to more evenly distribute the superconducting windings in the toroidal windings.

FIG. 59 is an end view of the sectional view of FIG. 58.

FIG. 60 is a flux directed permanent magnet machine that incorporates an outer array of permanent magnets arranged so as to direct the magnetic field into 4 magnetic poles. In an embodiment this outer magnet array rotates while the inner current carrying windings and backing steel remain stationery.

FIG. 61 shows the device shown in FIG. 60 with a section of the outer magnetic array removed in order to show the 4-pole current carrying windings.

FIG. 62 is a sectioned view of the embodiment of FIG. 60 clearly showing the outer permanent magnet array, the layer of current carrying windings and the inner layer of laminated steel.

FIG. 63 is a sectional view of the magnets and laminated internal steel flux guide of with the directions of magnetisation for each of the permanent magnet element in the outer array indicated.

FIG. 64 is a magnetic field plot of the device shown in FIG. 60.

FIG. 65 shows an 8 pole flux directed permanent magnet device. This is a variation of the device shown in FIG. 60 but with a higher pole count.

FIG. 66 shows the embodiment illustrated in FIG. 65 but with a section of the external magnet array removed in order to show the multi-phase current carrying stator windings.

FIG. 67 is a sectional view of the embodiment of FIG. 65 clearly showing the outer rotating array of permanent magnets as well as the inner current carrying windings and internal steel flux guides.

FIG. 68 is a sectional end view of the embodiment of FIG. 65 with directions of magnetization of the elements of the flux directed permanent magnet cylindrical array shown.

FIG. 69 is a magnetic field plot of the 8 Pole embodiment shown in FIG. 65.

FIG. 70 shows a flux directed permanent magnet device where the internal steel flux guide has been replaced by an internal permanent magnet array that is functionally magnetized as an external Halbach cylinder.

FIG. 71A is an end view of the two layers of rotating permanent magnet arrays from the embodiment of FIG. 70. The arrows indicate the relative direction of magnetisation of the array elements in a radially repeating pattern.

FIG. 71B shows the same view as FIG. 70A and indicates multiple flux-directing section and circulating paths facilitated by the flux directing assembly of FIG. 71A.

FIG. 72 is a sectional magnetic field plot of the device of FIG. 70 showing the two layers of functionally magnetized cylindrical arrays.

FIG. 73 shows a permanent magnet motor/generator featuring an internal permanent magnet and external steel flux guides. The above differs from previously disclosed embodiments in that both the permanent magnet and the outer steel flux guide rotate together to further reduce core loss in the steel.

FIG. 74 is an external view of a magnetic torque transfer coupling based on the interaction of the magnetic field created by an external magnetized Halbach cylinder mounted inside an internally magnetized Halbach cylinder.

FIG. 75 is a sectional view of the device of FIG. 74 showing the physical arrangement of the various layers of the magnetic coupling.

FIG. 76 shows the magnetic coupling of FIG. 74 illustrating the two cylindrical arrays of permanent magnets that create the internal and external Halbach cylinders that form the two halves of the torque transmission assembly of the coupling.

FIG. 77 is an end view of the magnetic elements of the device shown in FIG. 74. The arrows show the pattern of relative directions of magnetization of the internal and external Halbach cylinders that repeat around the cylinders.

FIG. 78 is a magnetic field plot of the flux directed magnetic coupling shown in FIG. 76.

FIG. 79 shows an alternative embodiment of the magnetic coupling comprised of two circular linear Halbach magnet arrays where the predominant direction of the interacting magnetic field is along the axis of rotation of the device. The two halves of the coupling are sequentially magnetized in a manner similar to that shown in the previously disclosed axial Halbach style magnetic gearbox.

FIG. 80 shows an epicyclical magnetic gearbox constructed from a series of Halbach cylinders. The central externally magnetized cylinder is the ‘sun’ gear whose magnetic field interacts with the set of four ‘carrier’ gears that are also externally magnetized. The carrier gears transmit torque to the outer ‘annulus’ gear—an internally magnetized Halbach cylinder.

FIG. 81 is an end view of the epicyclical gear shown in FIG. 80.

FIG. 82 is a magnetic field plot of the epicyclical gearbox shown in FIG. 80.

FIG. 83 shows a flux directed permanent magnet machine featuring an internal magnetic array that rotates and a stationary set of external brushless current carrying windings according to an embodiment.

FIG. 84 shows the embodiment of FIG. 83 with the external laminated steel shroud removed to show the multi-phase current carrying windings.

FIG. 85 shows the flux directed permanent magnet assembly of FIG. 83 shown in isolation.

FIG. 86 shows the assembly shown in FIG. 85 with the end plate removed and the directions of magnetisation of each of the elements in the permanent magnet array shown.

FIG. 87 is an end view of the partial assembly shown in FIG. 86 further indicating the directions of magnetisation of the elements of the permanent magnet array.

FIG. 88 is a plot of the magnetic field through a central cross section of the device of FIG. 83 showing a 16 pole device.

FIG. 89 shows a flux directed permanent magnet machine with an outer rotating permanent magnet array and the outer magnet array features additional backing steel to strengthen and direct the magnetic field.

FIG. 90 shows the embodiment of FIG. 89 but with the rotating components removed showing the current carrying windings and the laminated steel cylinder they are attached to.

FIG. 91 shows the rotating components of FIG. 89 in isolation showing the internally magnetised permanent magnet Halbach cylinder and the layer of backing steel used to strengthen and reinforce the magnetic field in the gap.

FIG. 92 is an end view of the isolated rotor components of FIG. 91 showing the direction of magnetisation of elements of the permanent magnet array.

FIG. 93 is a plot of the magnetic field through a central cross section of the device of FIG. 89 showing a 16 pole external rotor device.

FIG. 94 shows a superconducting flux directed machine wherein the current carrying windings and attached laminated back steel remain stationary while the flux directing coils rotate contained within a rotating cryostat according to an embodiment.

FIG. 95 illustrates a variation of the flux directed superconducting machines that uses simplified internal flux directing coils.

FIG. 96 shows the internal permanent magnet array from the flux directed permanent magnet coupling that shows an additional eddy current brake cylinder made from conductive material according to an embodiment.

FIG. 97 illustrates the device shown in FIG. 96 but with the eddy current braking layer positioned such that the brake is engaged.

FIG. 98 shows the configuration in FIG. 97 engaging the couplings brake achieved by shifting the conductive brake cylinder into the magnetic field created in between the inner and outer magnetic arrays that create the magnetic coupling. The arrow indicates the direction that the cylinder must be shifted to engage the brake.

FIG. 99 is a detailed cut-away view of the flux directed magnetic coupling with additional support structures shown in place according to an embodiment.

FIG. 100 shows an alternative detailed cut-away view of the flux directed magnetic coupling showing the additional locating spigots and bearings.

FIG. 101 shows an alternative embodiment of the flux directed magnetic coupling wherein the locating spigots have been extended and two pairs of additional support bearings are used.

FIG. 102 shows an epicyclical flux directed magnetic gearbox similar that that previously disclosed, that features 4 discrete directions of magnetisation per pole to improve flux containment and the strength of the torque transfer.

FIG. 103 shows the embodiment of FIG. 103 with the supporting structure remove in order to show the positioning of the sun, carrier and annulus magnetic gears.

FIG. 104 is an end view of the arrangement shown in FIG. 103 showing the directions of magnetisation for each of the discrete permanent magnetic elements that form the sun, carrier and annulus permanent magnetic gears.

FIG. 105 is a detail view of the end view illustrated in FIG. 104 showing the magnetisation of the gear elements.

FIG. 106 is a magnetic field plot showing the magnetic field created by the epicyclical magnetic gear arrangement shown in FIG. 104.

FIG. 107 shows an assembly that uses two separately controlled flux directed permanent magnet motors and epicyclical magnetic gearboxes shown in context with the axle of a vehicle.

### DESCRIPTION OF EMBODIMENTS

While the term ‘magnetic field’ is generally a vector quantity to represent directional magnetic field strength and the term ‘magnetic flux’ is generally a scalar quantity to represent non-directional magnetic energy flow, where the context requires, however, both terms in this specification are used interchangeably and their meanings are not limited by such strict use. For a non-limiting example, description of magnetic flux with corresponding static illustrations of magnetic field should be read with the magnetic flux associating with a directional context and the magnetic field associated with a flowing context.

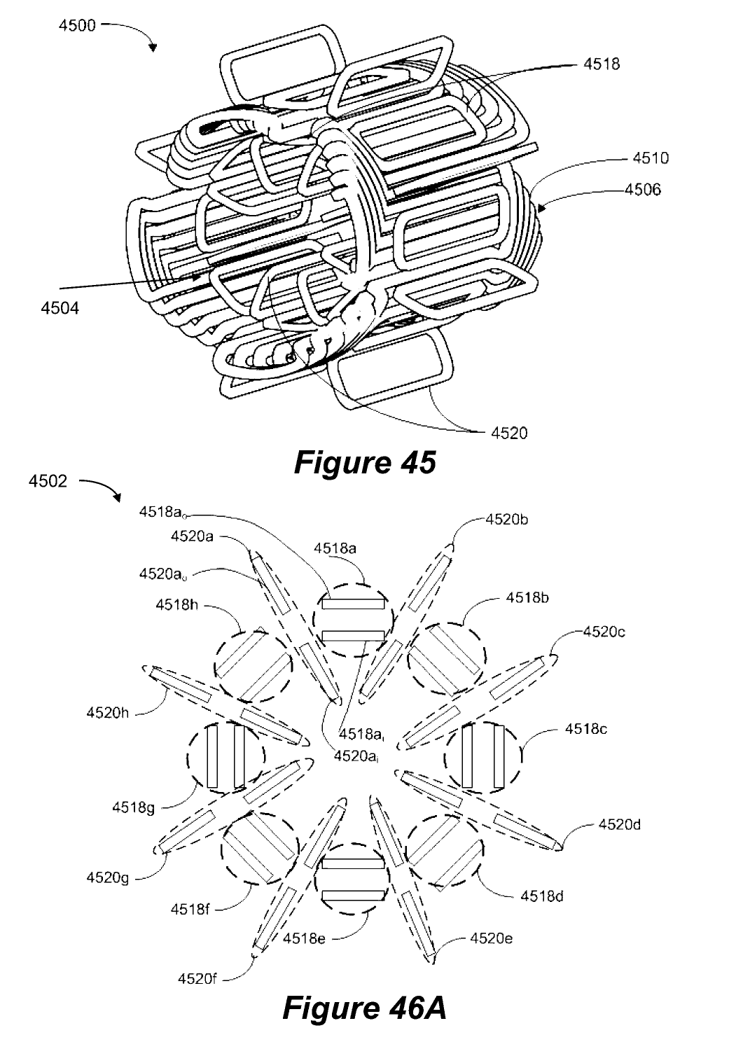

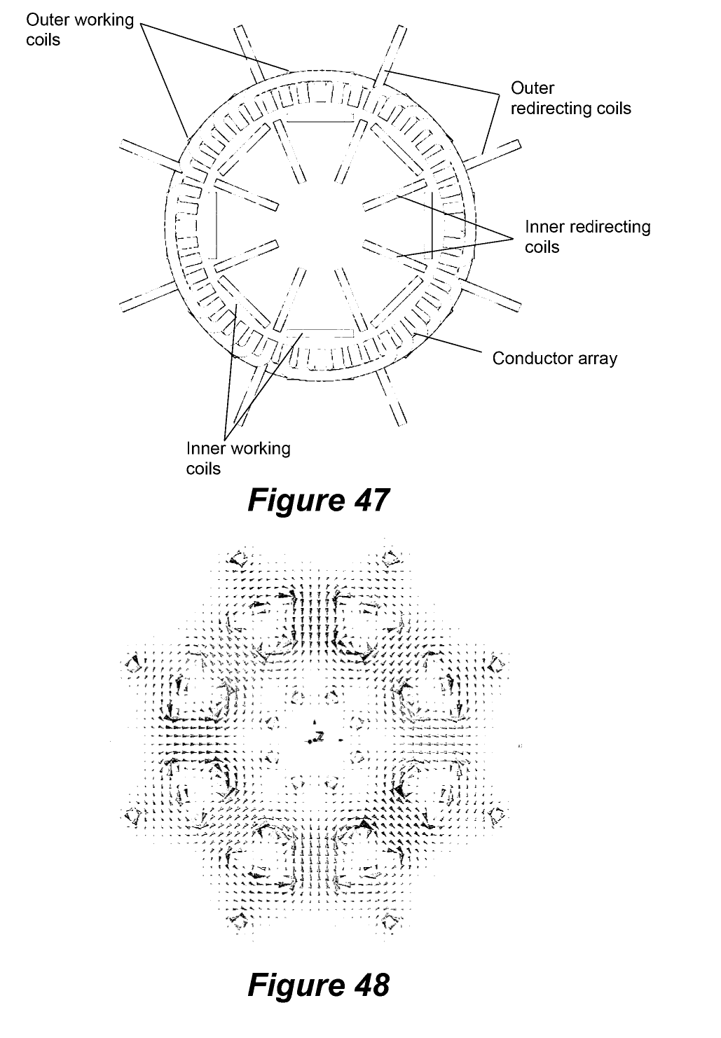

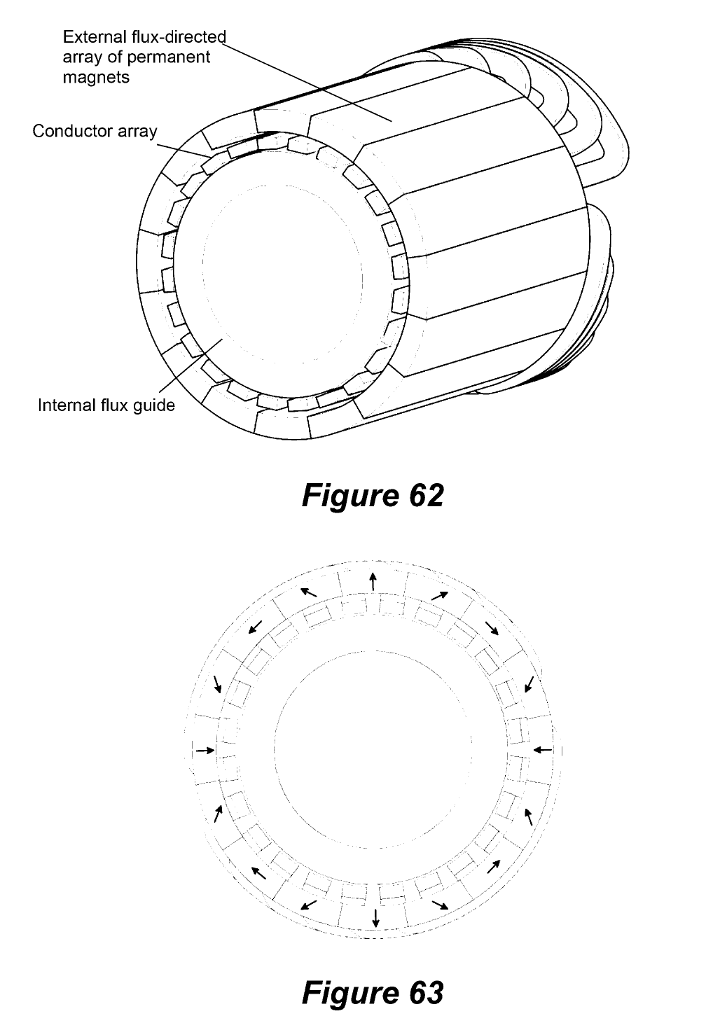

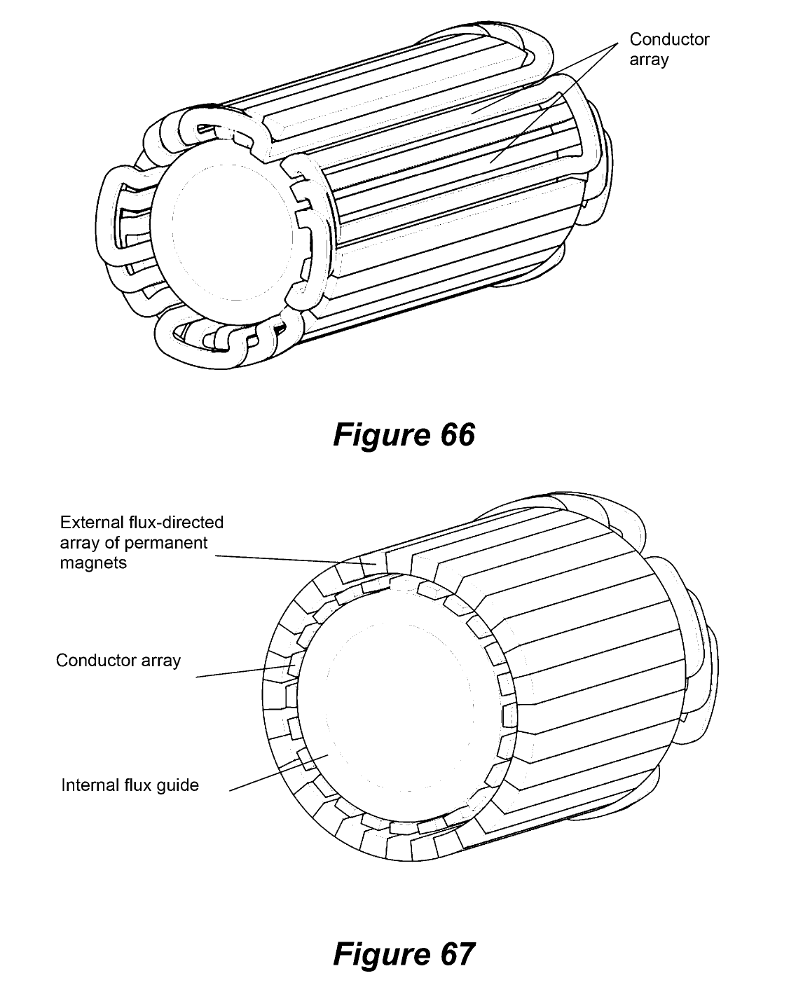

Aspects of the present invention in one form, reside broadly in an electromagnetic device including a flux directing assembly to generate a magnetic field, a gap having multiple gap regions, and a conductor array located within the gap to allow interaction between a current flow in the conductor array and the relative movement of the conductor array to the flux directing assembly in the presence of the magnetic field. In some configurations, as exemplified in FIGS. 45-78 and 94, the gap is a generally annular space in between an inner cylindrical surface and an outer cylindrical surface. These cylindrical surfaces are conceptual only and are roughly defined by components of the flux directing assembly on the inner and outer sides of the gap.

The flux directing assembly includes one or more working elements (also referred to as primary elements/coil or pole elements/coils in this disclosure) configured to direct magnetic flux across the corresponding gap regions and redirecting elements (also referred to as interstitial elements or coils in this disclosure) configured to redirect the magnetic flux back towards the working elements. At least a portion of a working element and a redirecting element form a flux directing section. The flux directing assembly may include multiple such flux directing sections. Each flux directing section is arranged adjacent to at least one other flux directing section, such that the adjacent flux directing sections share a common working element. Each flux directing section is configured to facilitate a circulating magnetic flux path about itself.

Furthermore, each pair of adjacent flux directing sections is arranged about a common gap region of the multiple gap regions and configured to direct at least part of the respective circulating magnetic flux paths across the common gap region in a substantially similar flux direction substantially perpendicular to the current flow direction.

The working elements and the redirecting elements may each be formed of one or more electromagnetic coils or permanent magnets. According to a particular embodiment, each common working element about adjacent flux directions sections is formed of a single working coil or permanent magnet, positioned either on the inner or outer side of the corresponding gap region. In another embodiment, each common working element is formed of two working coils or permanent magnets, one positioned on the outer side of the gap region and another positioned on the inner side of the gap region. In either embodiment, each working coil/permanent magnet therefore forms one half of the common working element shared by two adjacent flux directing sections. The working coils/permanent magnets are spaced from one another allowing the mounting for the conductive element to extend into the magnetic field generated by the common working elements.

Similarly, in some embodiments, a redirecting element may have a single redirecting coil/permanent magnet positioned on either the outer or inner side of the gap. In some other embodiments, the redirecting element may have two redirecting coils/permanent magnets—one positioned on the outer side of the gap and another placed on the inner side of the gap. In yet other embodiments, the number of inner and outer redirecting coils/permanent magnets can be increased to two, three, four, five, six, or more positioned on either side of a the gap and between two working elements on each side.

In other embodiments, the outer and/or inner working coils/permanent magnets may each or collectively be interchanged with one or more flux guides, for example, in the form of multiple pole pieces or a single cylinder having a hollow centre. The flux guides may be formed of any suitable material, such as ferromagnetic or paramagnetic materials without departing from the scope of the present disclosure.

When the flux guides are in the form of multiple pole pieces, the pole pieces may be substantially aligned with the working coils or permanent magnets on the opposite side of the gap regions and function as part of the working elements. Air gaps between the pole pieces may allow passage of magnetic flux between adjacent pole pieces.

Alternatively, when the flux guide is in the form of a hollow cylinder, the portions of the cylinder that are substantially aligned with the working coils/permanent magnets on the opposite side of the gap regions function as part of the working elements whereas the remainder of the hollow cylinder functions as part of the redirecting elements.

Each of the working coils and redirecting coils may be substantially rectangular in shape.

In some embodiments, the coils may be formed of superconductor material. In these embodiments, the portion of the electromagnetic device that is formed of superconductor material is at least partially enclosed within a cryogenic envelope or cryostat in order to cool the superconducting coils. When the flux directing assembly and the conductive element are both formed of superconductor material, the magnetic flux assembly may be positioned in a first cryostat and the conductive element may be provided in a second cryostat which is movable relative to the first cryostat. Typically, the first cryostat is fixed and the second cryostat rotates within at least a portion of the first cryostat with the conductive element fixed within the second cryostat.

The superconducting coils of the flux directing assembly may be formed by winding superconducting tape or wire to form a coil. These types of coils may be preferred due to their near zero electrical resistance when cooled below the critical temperature. They also allow high current density and hence, allow creation of a large (and dense) magnetic field.

The magnetic field generated by the flux directing assembly may be permanent or changing. In some instances, the magnetic field is a permanent field with the field of the at least one conductive element being the changing field in order to provide the motive force for moving the at least one conductive element through interaction with the magnetic field.

In some instances, where a changing field is provided, this is achieved through a physically or electronically commutated direct current supply or an alternating current supply.

It should be appreciated that the characteristics of the flux directing assembly and the at least one conductive element will be determined according to the application.

The coils can be provided in any number of layers, with some example embodiments using multiple layers.

Moreover, the electromagnetic device can have a reciprocating or rotating configuration with the at least one conductive element mounted for movement according to either (or both) of these principles. According to the rotating embodiment, the flux directing assembly may include a set of coils in order to produce the magnetic field. Typically, the at least one conductive element is located within a gap in the flux directing assembly and rotates about an axis substantially perpendicular to the dominant direction of the magnetic field created by the flux directing assembly in the gap.

In another broad form, the present invention resides in an electromagnetic machine having a number of magnetic elements, each having a north magnetic pole and/or field and a south magnetic pole and/or field positioned relative to one another to create an interstitial magnetic pole between adjacent magnetic elements and at least one conductor element located relative to the magnetic elements such that the conductor interacts with the magnetic poles and/or fields of the magnetic elements to produce electrical current or mechanical work.

A basis of operation of at least some disclosed devices is the interaction between a current carrying conductor and a magnetic field. This interaction results in an output torque developed in the device (in the case of a motor) or an output voltage and current (in the case of a generator). Some disclosed devices include one static or stationary magnetic field and one alternating field.

The magnetic field consists, at a fundamental level, of a magnetic pole created by either an electromagnetic coil or by a permanent magnet. The pole has a North and South orientation of the magnetic field.

In at least some disclosed devices, the generated magnetic field is used more than once, that is—that multiple paths are described through the magnetic field by the current carrying conductors in order to greatly increase the power density of the electrical machines.

The rotating machines (motors and generators) of some embodiments each have:
a rotating and a stationary component or,
a rotating and a counter-rotating component or,
a combination of rotating and counter-rotating and stationary components.

In an embodiment, the driving or generating path remains stationary while the flux directing assembly rotates. The reverse scenario with moving driving or generating windings and stationary flux directing assembly is also workable, one characteristic of the first embodiment is that the higher currents that are constantly reversing polarity in the driving or generating coils do not have to be transmitted via a sliding contact or brush, reducing electrical losses in the device.

On the other hand, if there is application requirement that the spinning mass of the device be reduced to allow for rapid stopping, starting, acceleration and deceleration, there may well be an advantage in spinning the driving or generating path instead of the flux directing assembly. In this case, the design of the machine should favour a larger number of windings in the flux directing assembly. The operating direction of the machines presented in this document can be reversed by a reversal of the current direction in the background field coils or driving/generating path windings.

While the images and descriptions in this document present the embodiments in terms of rotating electrical machinery, it would be clear to anyone skilled in the art that the principles presented could be applied to linear machines as well as rotating devices.

The devices disclosed in this document also concern the production of mechanical work from an input of electrical voltage and current (motors) or the production of electrical voltage and current from the application of mechanical work (generators).

The motors/generators of the disclosed embodiments comprise a rotating part (rotor) and a stationary part (stator). In at least some devices disclosed, the primary function of the stator is to provide a high strength magnetic field in which the rotor rotates. The rotor can be powered with a current that changes direction in concert with the relative change in direction of the magnetic field (that is, as the rotor moves from one magnetic pole to the next) in the case of a motor. In the case of a generator, the movement of the rotor generally results in the generation of an alternating voltage and current.

In at least some devices disclosed herein, electrical energy is converted into mechanical work or mechanical work is used to create electrical energy through the action of a current carrying conductor moving within a magnetic field.

In some disclosed configurations, the magnetic field may be created by a series of adjoining electromagnetic coils that are wound in the form of toroids or sections of toroids in order to direct the magnetic field into a working region or a series of working regions through which a current carrying conductor moves. These toroidal sections both direct the magnetic field such that it is substantially perpendicular to the direction of current flow in the current carrying conductors/windings and contain the magnetic field largely within the device itself. In this manner, a high power device can be constructed limiting or eliminating the need for steel or ferromagnetic flux guides.

A gap region may exist between toroidal winding sections to allow for the mechanical placement and operation of the current carrying conductors.

Some disclosed configurations show the toroidal winding sections and arrangements built from superconducting wire and current carrying conductors from normal conducting material such as copper. It would be clear to a person skilled in the art that either part of the device could be readily constructed from either superconducting or normal conducting material.

In light of this disclosure, some features include (either separately or in one or more combinations):
That any of the embodiments disclosed relying on toroidal coils could be readily constructed using arrangements of discrete sub-coils (open toroids/windings) or by a continuous winding of conductive material in a toroid or toroidal sector (sealed or closed windings/toroids)
That where magnetic field windings have been used to direct flux to an air gap or working region, that these windings could be replaced by permanent magnetic material, with or without ferromagnetic flux guides, that direct the flux to these regions in a like fashion.
That where attributions have been made regarding one part of the device being the ‘rotor’ and another being the ‘stator’ that these designations simply imply relative rotation between the two parts and that the rotating and stationary roles or designations could readily reversed such that previously stationary parts rotate and rotating parts are stationary.
That with devices that operate on the principle of maintaining one DC or stationary (background) magnetic field and one alternating magnetic field that it is equally acceptable that the background field alternate in polarity and the current carrying windings that previously produced the alternating field produce a stationary field.
That where an alternating current is employed the wave form of that current could suitably be any shape of waveform such that continuous rotation or generation of the device results and that such waveform maybe shaped to produce a minimum of ripple in the power output of the motor or generator.
That where a device has been described as a motor, producing mechanical work upon the application of electrical energy, that the reverse scenario of a generator that produces electrical energy on the application of mechanical work is also claimed.
That where a device has been described as a generator that the reverse scenario where the device operates as a motor is also claimed.

Any of the features described herein can be combined in any combination with any one or more of the other features described herein within the scope of the invention.

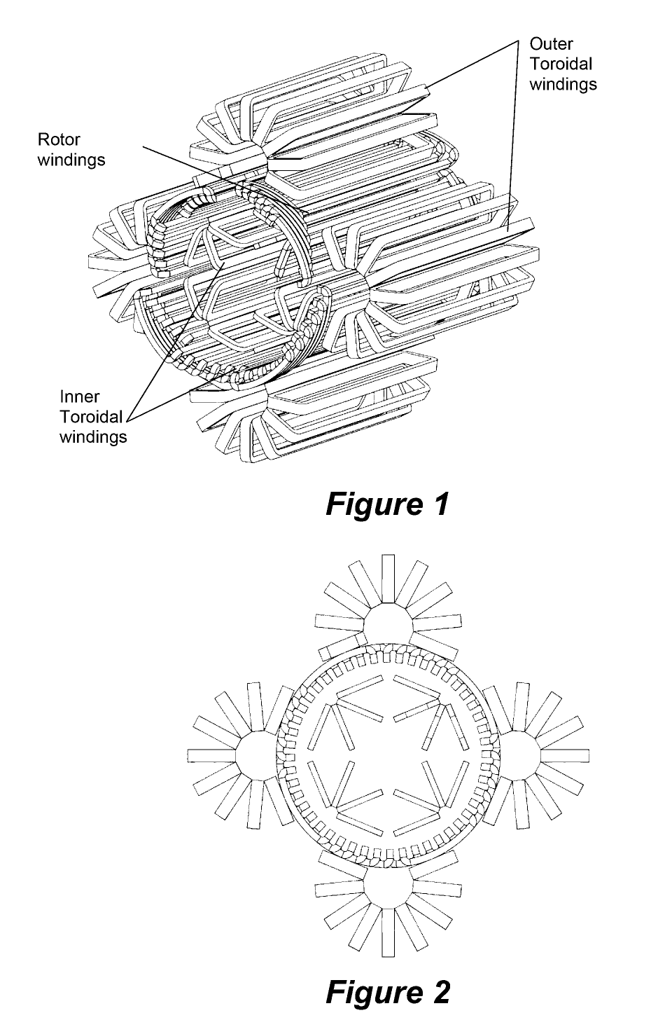

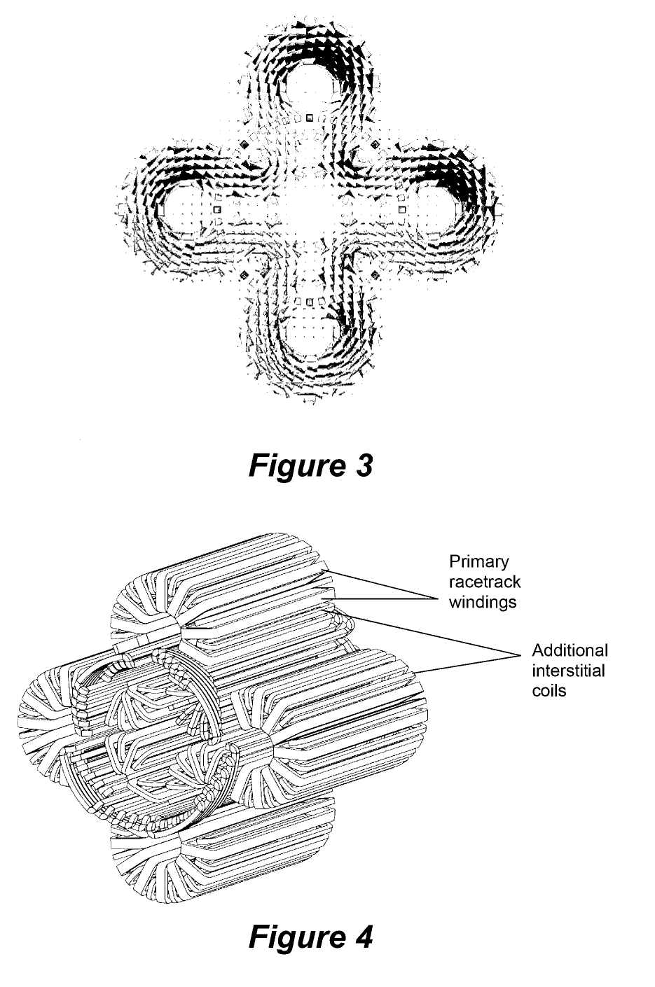

The embodiments shown in FIG. 1 and FIG. 2 show a star toroidal motor/generator with a reduced number of constituent racetrack coils in the outer and inner toroidal windings in order to simplify the construction of the device. The reduction in the number of coils does not significantly affect the power if similar quantities of superconducting wire are used. FIG. 3 shows a magnetic field plot of the embodiment of FIG. 1.

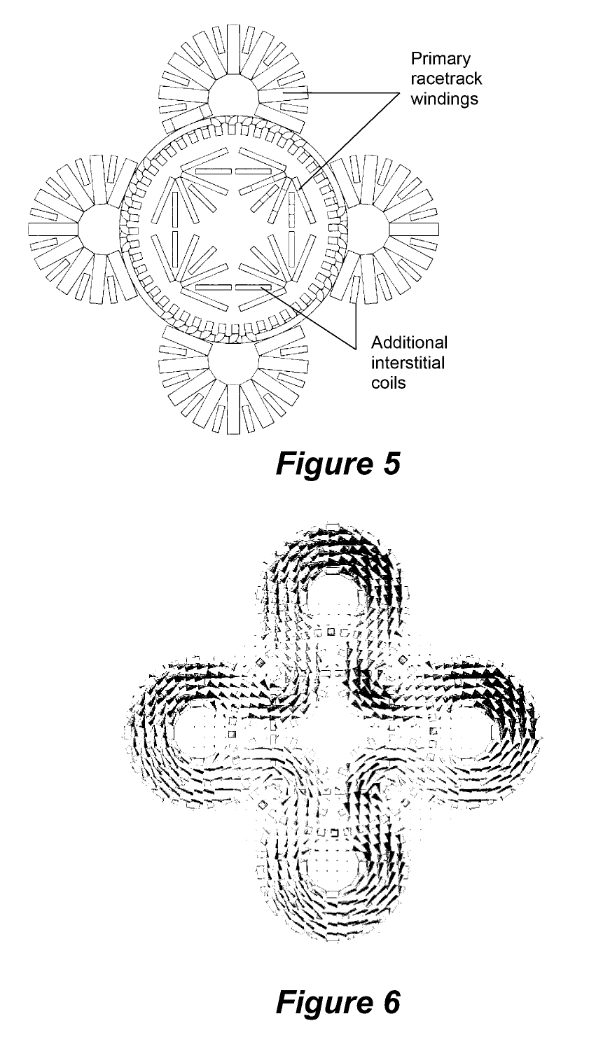

FIGS. 4 and 5 show a variation where a second set of interstitial coils have been placed in the gaps between the main racetrack coils of the inner and outer toroidal windings. These interstitial coils help to even the strength of the magnetic field out over the radial thickness of the toroidal windings. As the limiting magnetic field in the superconducting windings is usually produced on the inner surface of the inside of the toroidal windings, the interstitial coils increase the power of the device without increasing this limiting internal magnetic field. FIG. 6 shows a magnetic field plot of the embodiment of FIG. 4.

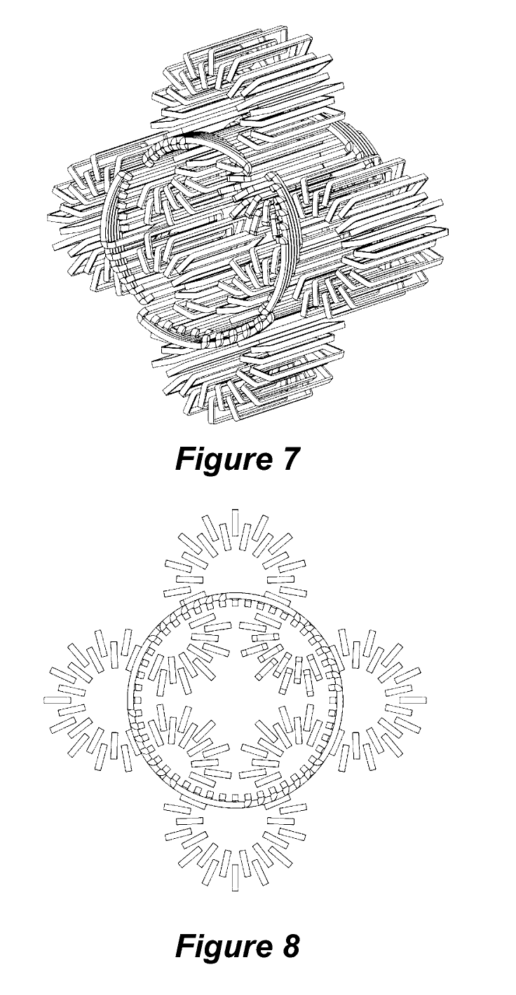

FIGS. 7 and 8 show a variation of the device shown in FIG. 1 where the redirecting coils are the same size as the main racetrack coils of the toroidal sectors in order to better distribute the magnetic field through the toroidal windings.

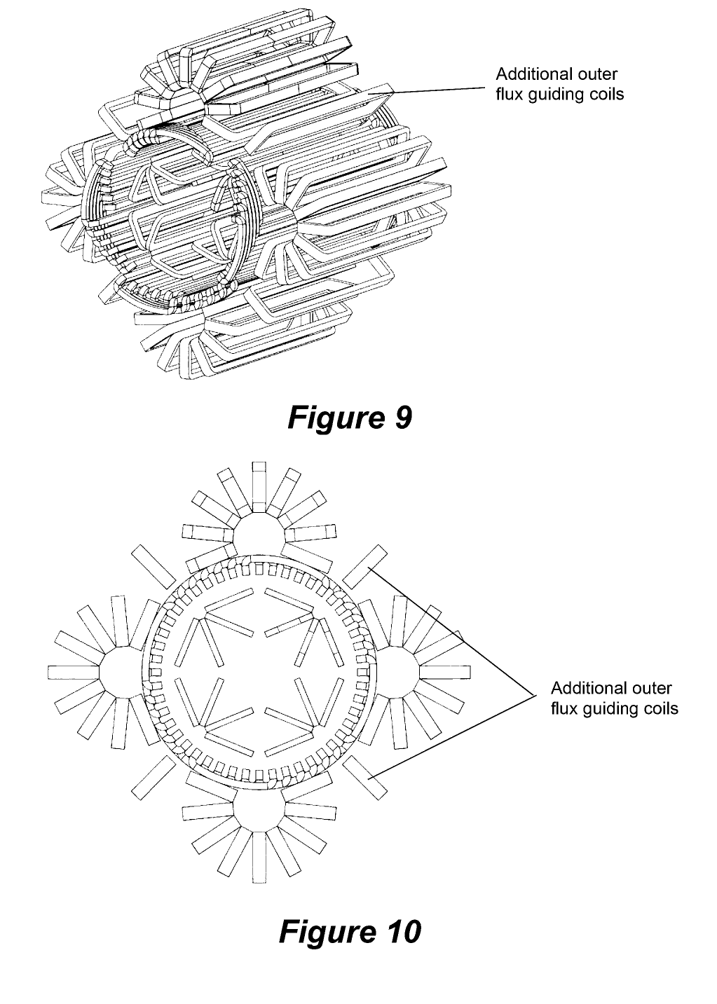

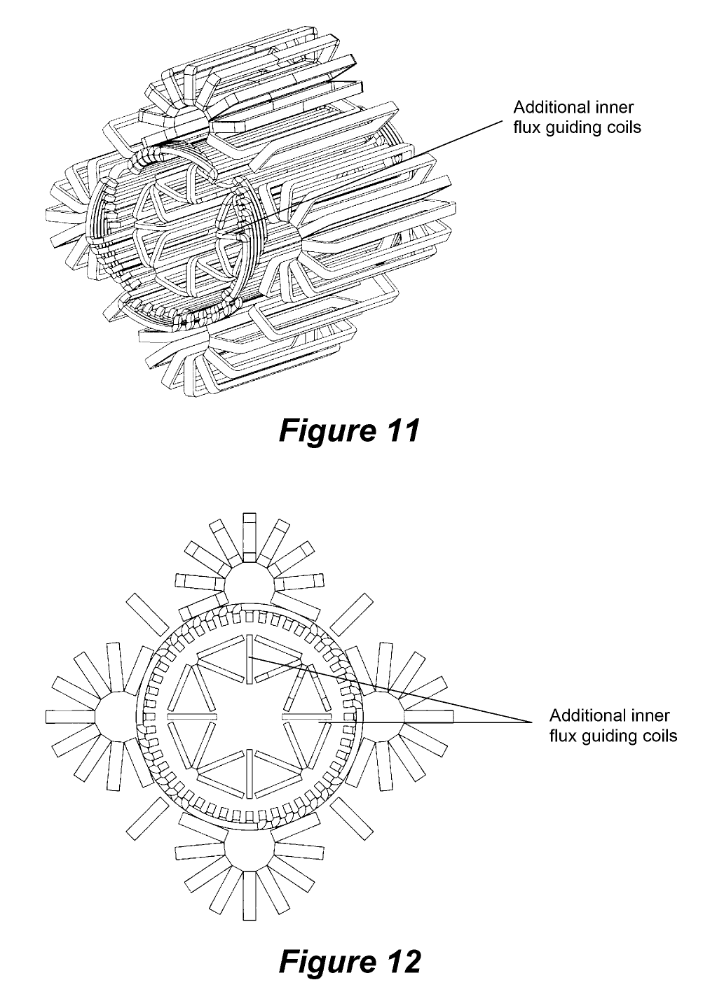

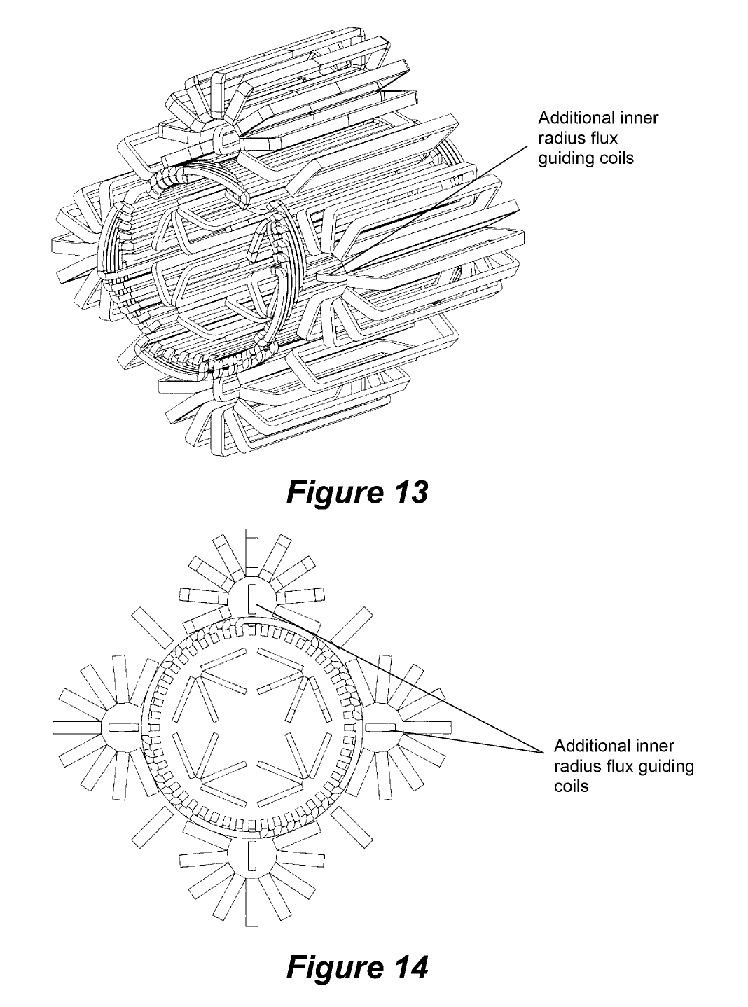

The embodiments shown in FIG. 9 to FIG. 14 show a variety of placements of additional windings in between toroidal sectors and in the middle of the inner radius of the toroids. These additional windings cancel stray magnetic field that is jumping between successive toroidal sectors and help to direct the magnetic field from the toroids through the working region or gap.

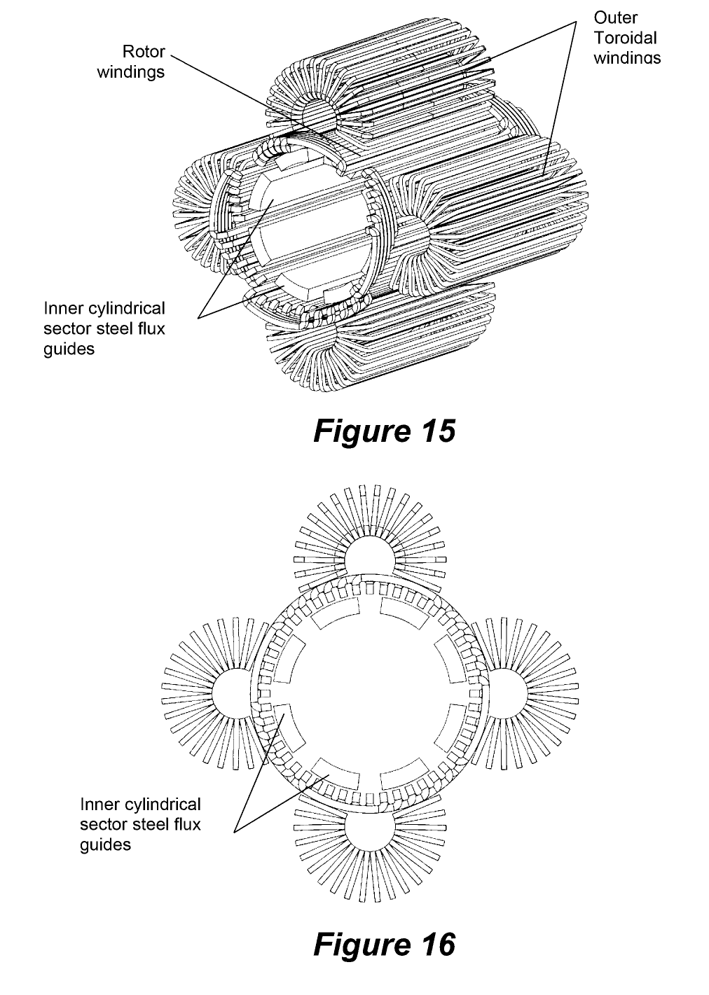

The device shown in FIGS. 15 and 16 replaces the internal superconducting toroidal windings with a set of steel or ferromagnetic flux guides. These flux guides are sectors of a cylinder that are placed opposite the pole faces of the outer toroidal windings, on the other side of the rotor windings and help to guide the magnetic field between successive pole segments.

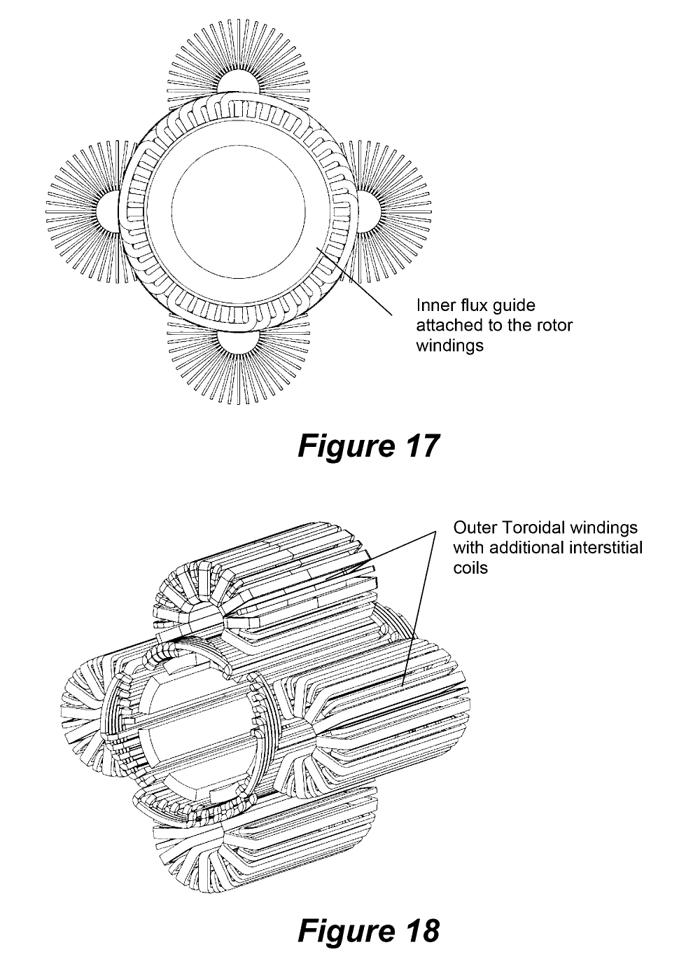

FIG. 17 shows an embodiment wherein the steel/ferromagnetic flux guide consists of a cylinder of laminated material. The flux guide is attached to the rotor windings and moves with them. The laminations in the material reduce eddy current and parasitic loss.

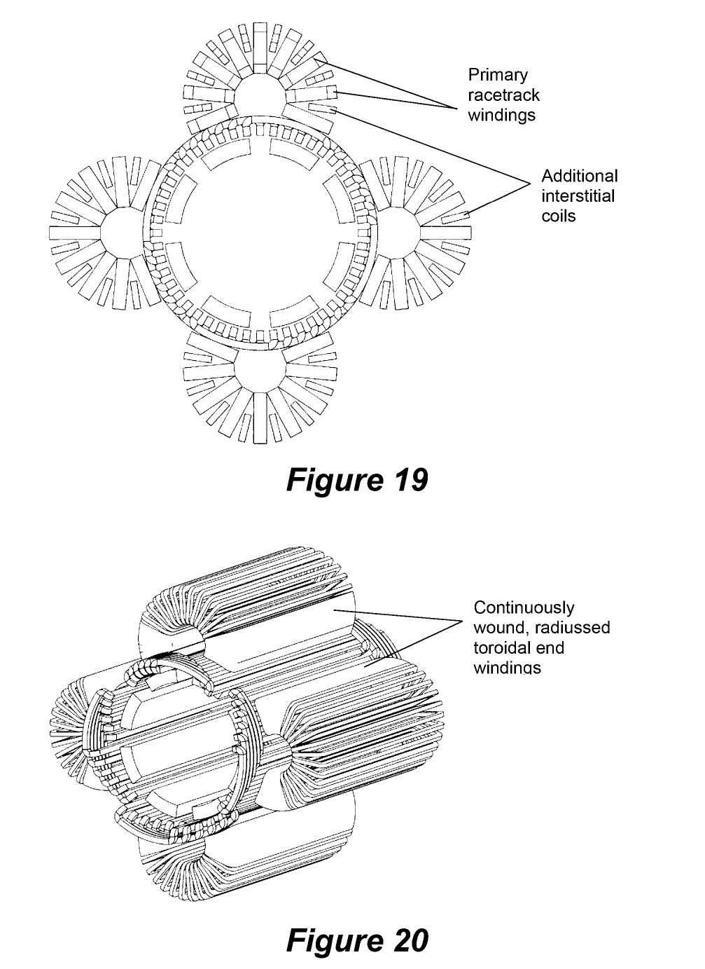

FIG. 18 and FIG. 19 show a variation on the device shown in FIG. 15 that employs secondary interstitial coils added to the outer toroidal windings in order to improve the homogeneity of the magnetic field in the toroid and across the working gap/region.

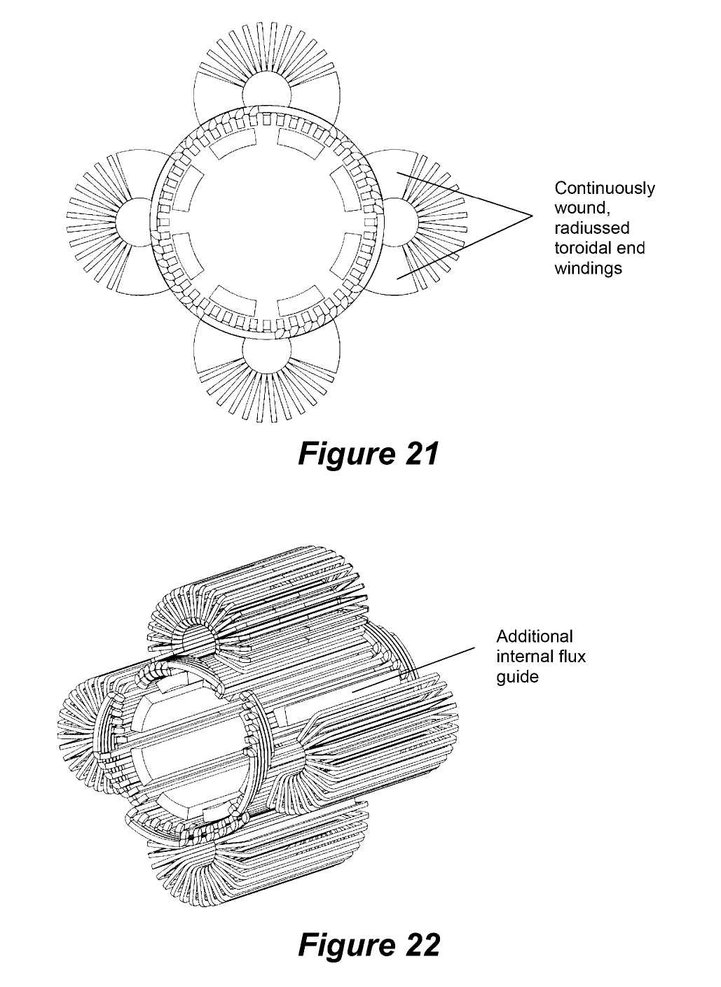

In a further embodiment of the star toroidal device FIG. 20 and FIG. 21 show a motor/generator where the ends of the toroidal windings are ‘sealed’, that is, wound continuously around a shaped former rather than constructed from discrete racetrack coils in order help prevent magnetic flux from jumping from toroidal sector to toroidal sector without passing perpendicularly through the working gap/region. This sealed end winding is also radiussed at the end adjacent to the rotor such that edges of the toroidal winding match the radius of the rotor windings.

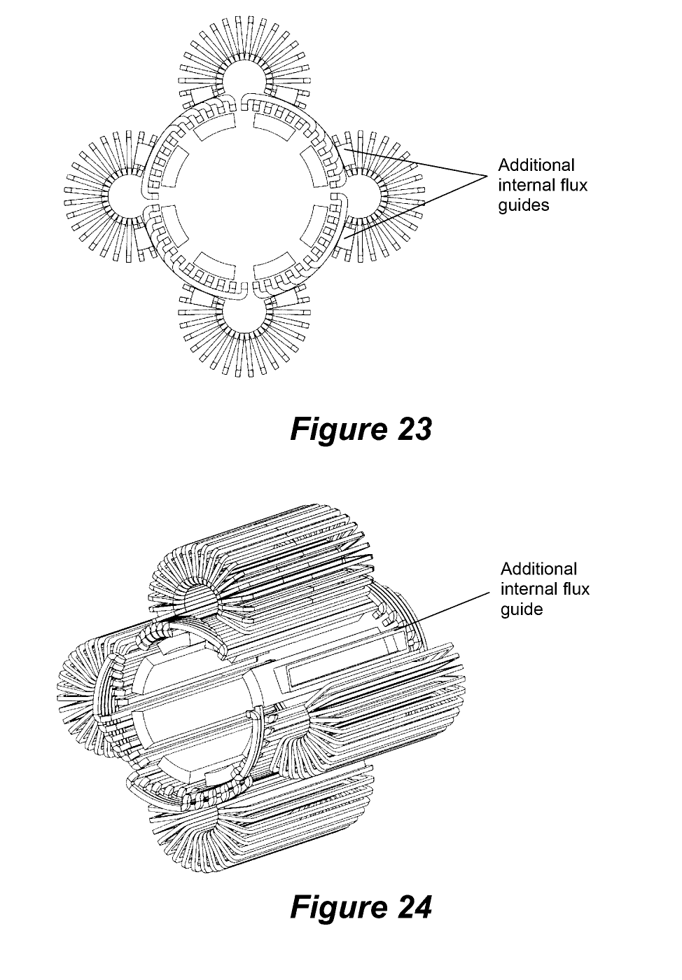

A further variation involves the use of additional steel flux guides in and around the toroidal windings themselves in order to contain magnetic field and direct it across the working gap region. FIGS. 22 and 23 show a variation where a steel/ferromagnetic bulk has been positioned in the centre at either end of the outer toroidal sectors near the rotor winding.

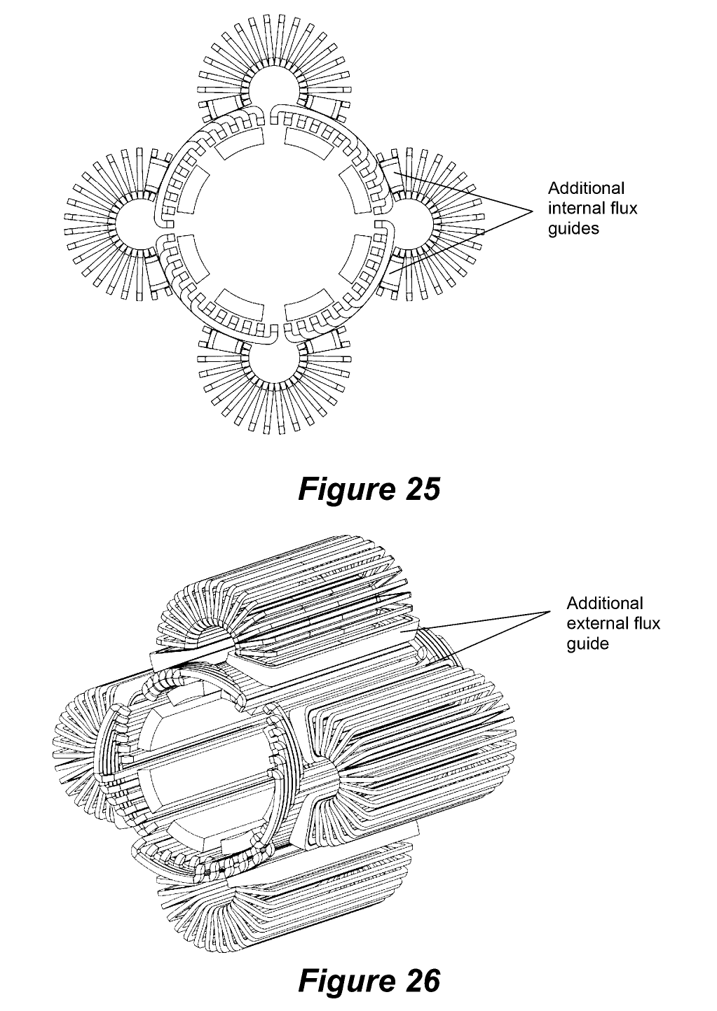

FIGS. 24 and 25 show a device similar to that shown in FIG. 22 but with the hollow ‘sock’ style steel flux guide following the internal contour of the toroidal windings. This contour has a constant thickness of steel/ferromagnetic material.

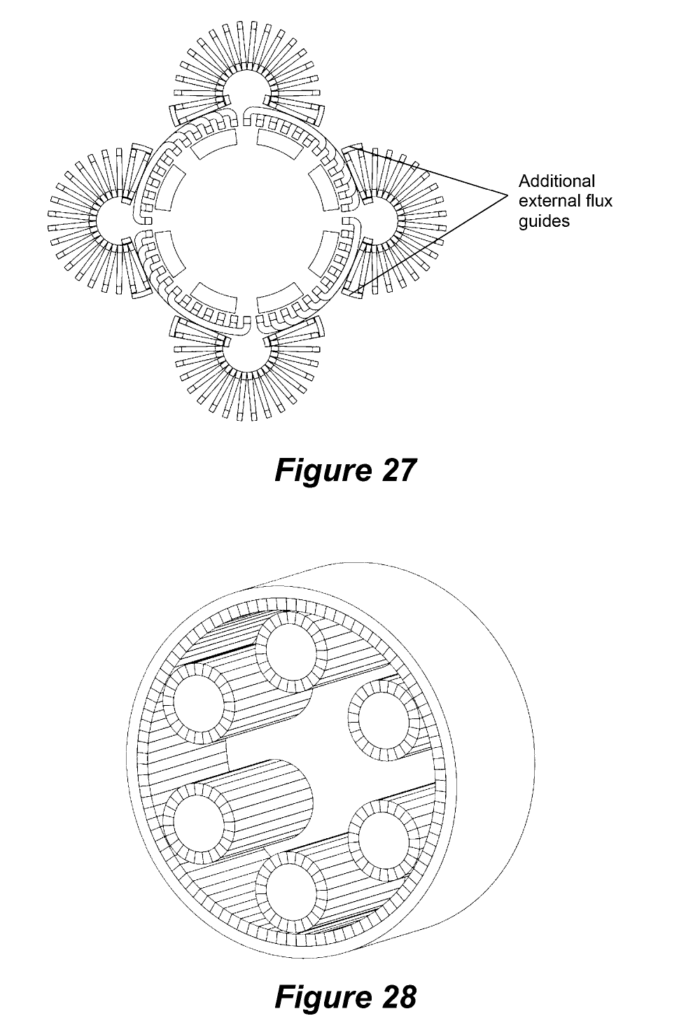

FIGS. 26 and 27 show a device similar to that shown in FIG. 24 but with the contour following steel ‘sock’ on the outside of the toroidal windings.

### Magnetic Gearboxes

The applicant's prior publication, such as PCT application no. PCT/AU2015/050333 published as WO2015192181 disclosed a magnetic gearbox that included a rotating crown and pinion rotors wherein the crown and pinions were sequentially radially magnetised North, South, North, South . . . etc. The relative number of poles between the crown and pinion was a function of the relative working diameters of the crown and pinions and ultimately the desired gear ratio of the final magnetic gearbox.

In further variation of that embodiment, the magnetisation of the magnetic material of the crown and pinions is arranged so as to form a Halbach magnetic array. The Halbach array consists of functionally magnetised sub-components that produce a strong magnetic field on one side of the array and very little magnetic field on the other side of the array. In a round form the magnetic gear consists of an internal Halbach cylinder (crown) and an external Halbach cylinder (pinion). The direction of magnetisation in a Halbach cylinder is functional and governed by:

M=Mᵣ[cos(kϕ)\hat{ρ}+sin(kϕ)\hat{ϕ}]

Where M is the magnetisation vector and k is the order of the Halbach cylinder. Positive values for k produce internal Halbach cylinders and negative k values produce external Halbach cylinders. The number of poles in the Halbach cylinder is equal to (k−1)*2.

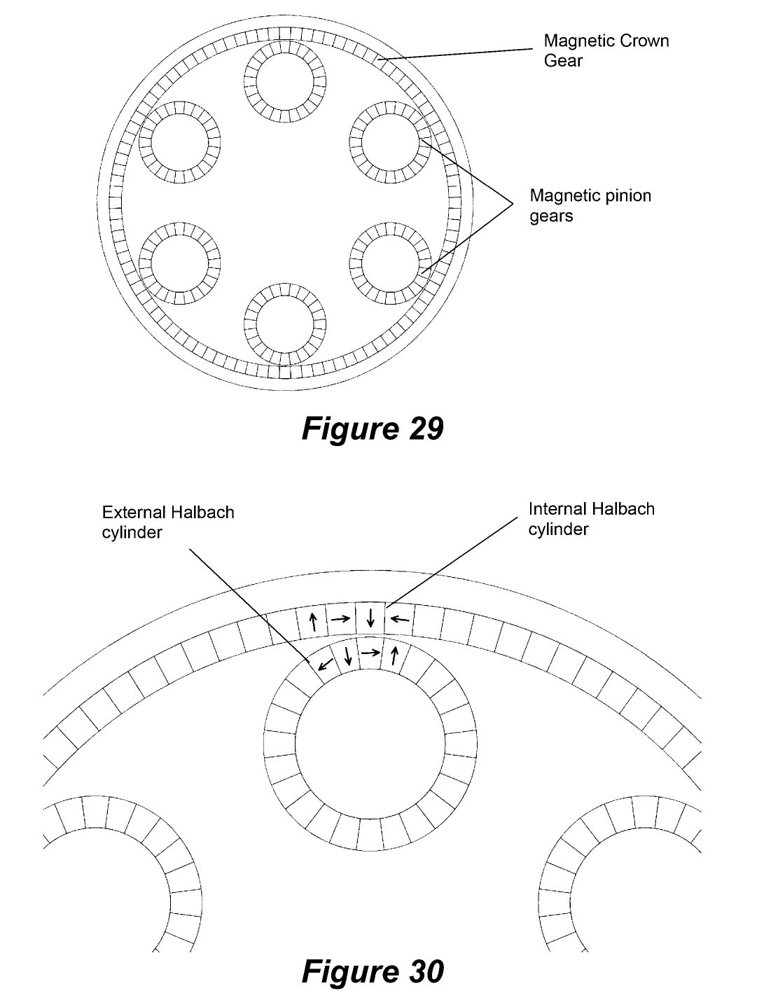

FIGS. 28, 29, and 30 show a magnetic gearbox where the components have been magnetised to form Halbach cylinders. In reality the functional magnetisation of a perfect Halbach cylinder is accomplished using a set of discrete magnetisations in a repeating pattern. This repeating pattern is shown in FIG. 30. The lack of field on the back faces of the Halbach cylinders removes the need for steel backing or flux guides.

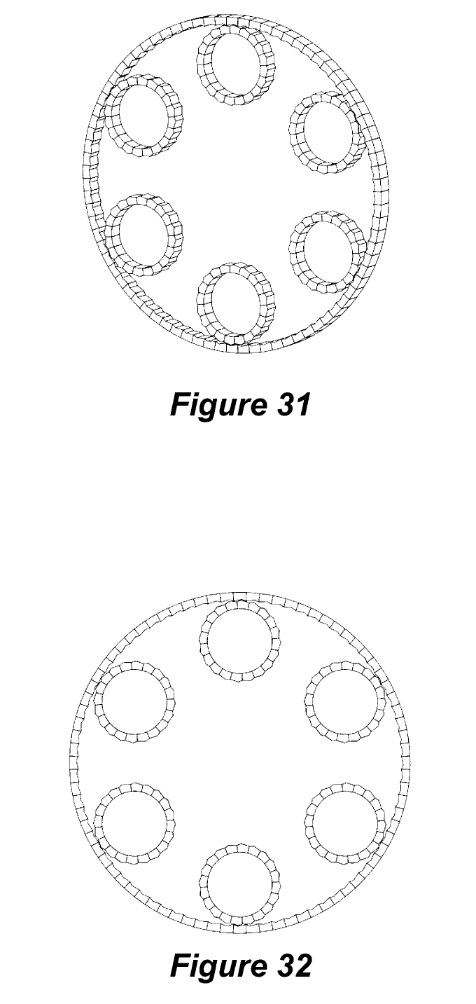

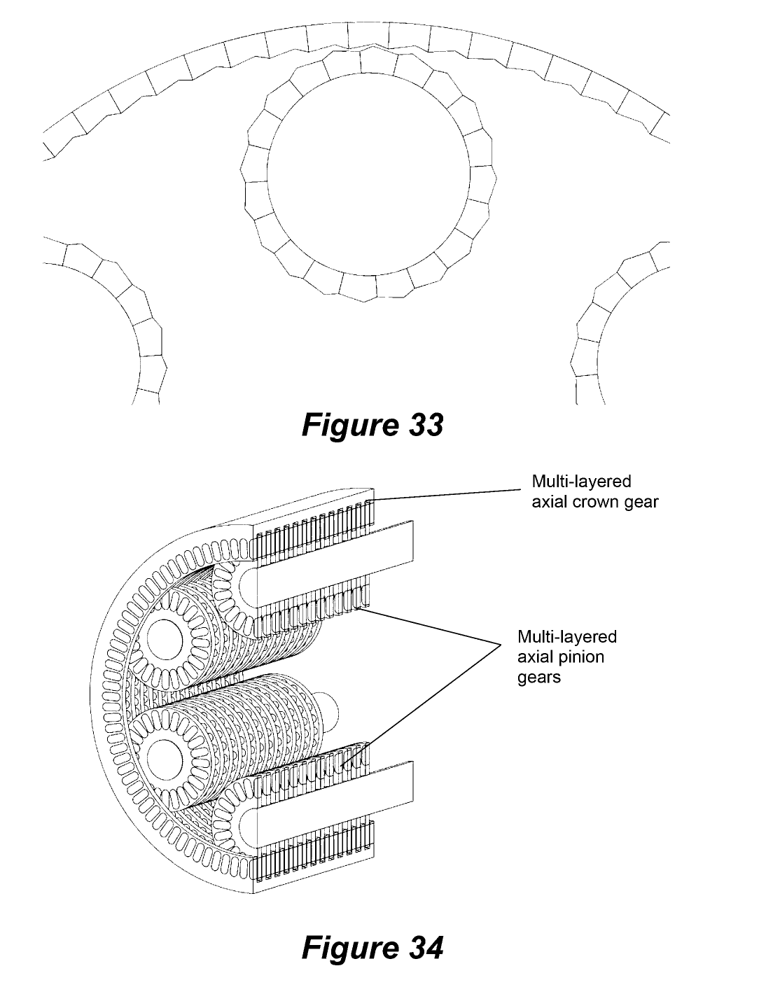

In further variation the elements that make up the magnetic gears are shaped such that they interlock. In normal operation the force at a distance provided by the magnets transmit torque with a gap between the interlocking elements. When subjected to overload the interlocking elements physically engage and transmit torque as a normal non-magnetic gear. This variation is shown in FIGS. 31, 32, and 33 and could be used with radially alternating North-South, All-North and All-South and Halbach style magnetisations.

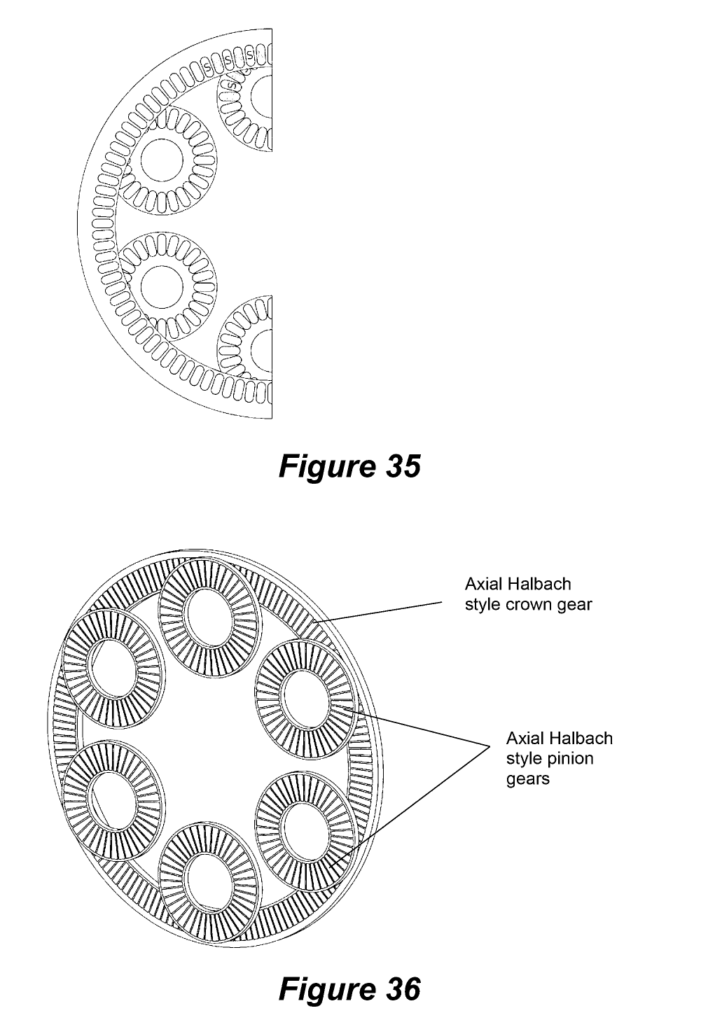

The device shown in FIGS. 34 and 35 consists of a multi-layer magnetic gearbox where the magnetic elements that make the gears are magnetised in an axial direction. Additional layers of interleaved gears can be added to increase the torque capacity of the device.

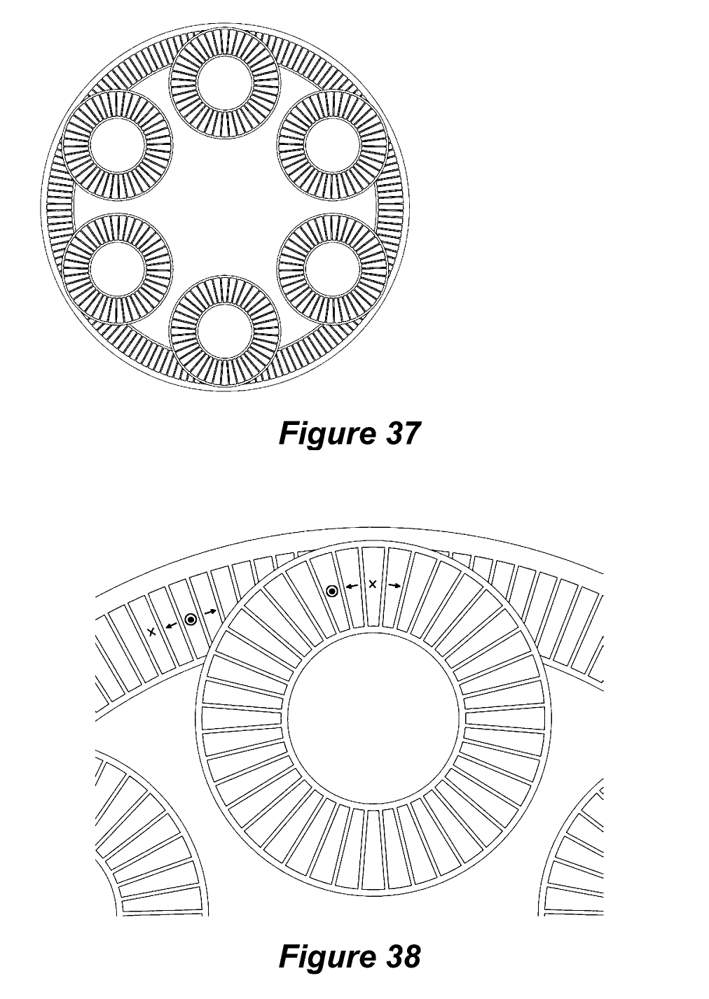

A further axial magnetic gearbox variation is shown in FIGS. 36, 37 and 38 where again the individual magnets that make up the magnetic gearbox are magnetised parallel to the axes of rotation of the machine. In this arrangement the individual magnetic element are magnetised in a pattern to form a linear Halbach array around the circumference of the crown and pinion rotors. The relative directions of magnetisation for a discrete embodiment of this type of Halbach style array is shown in FIG. 38. The Halbach array offers high magnetic field strength on the working side of the magnetic assembly with little or no stray magnetic field on the non-working side. It would be obvious to a person skilled in the art that this arrangement could be readily extended to multiple layered design, similar to that depicted in FIG. 34.

Any of the magnetic gearbox geometries disclosed could be magnetised in a number of ways while still transmitting torque between the magnetic gear elements. In addition to the alternating North-South and Halbach style magnetisations, the gear elements could also be magnetised in an All-North or All-South arrangement or any combination thereof.

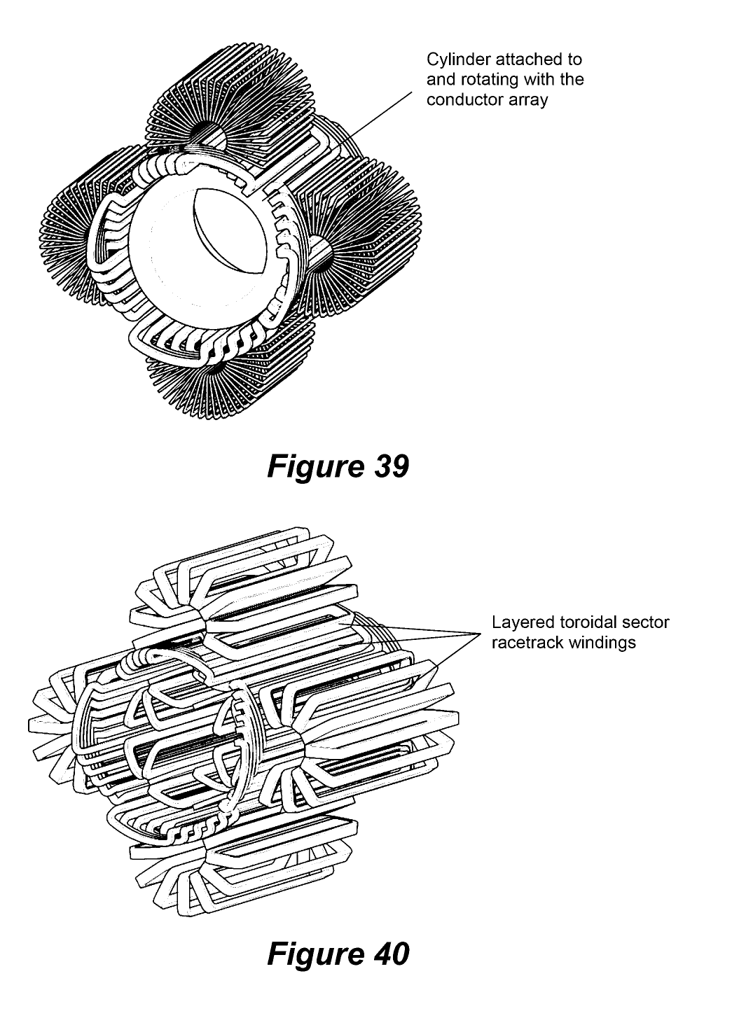

In a further variation of the Star Toroidal devices that feature an internal flux guide, instead of internal flux directing coils, this flux guide can be made from laminated ferrite based material that has low hysteresis and eddy current loss. If the flux guide is constructed as a complete cylinder then the flux guide could rotate with the current carrying windings, resulting in a simpler construction of the rotor. A device featuring this unified current carrying winding and flux guide structure is shown in FIG. 39. In this variation the flux guide is made from laminated, low core loss material and rotates in concert with the current carrying windings.

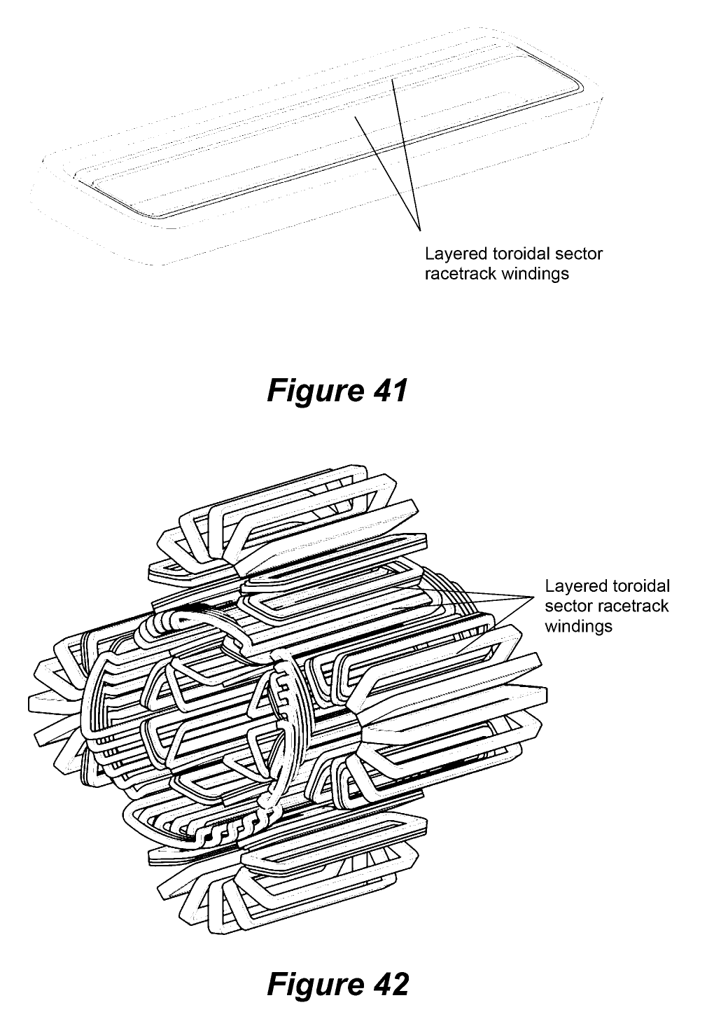

FIG. 40 and FIG. 41 show a further variation of the Star Toroidal device that aims to decrease the amount of superconducting wire used and increase the strength and uniformity of the magnetic field in the gap region (or in the region where the current carrying windings are located). This improvement is accomplished by subdividing the superconducting racetrack coils near the gap region in the manner shown in FIG. 41. In addition to subdividing these closer coils, the number of turns in the racetrack coils is redistributed such that the subdivided racetrack coils have a higher number of turns of superconducting wire than the other racetrack coils in the toroidal sector. Theses coils also have a higher number of turns than the rest of the coils in the toroidal sector. The division of the coils helps spread the peak field on the toroidal sector and increase the strength and uniformity of the magnetic field in the working region/gap.

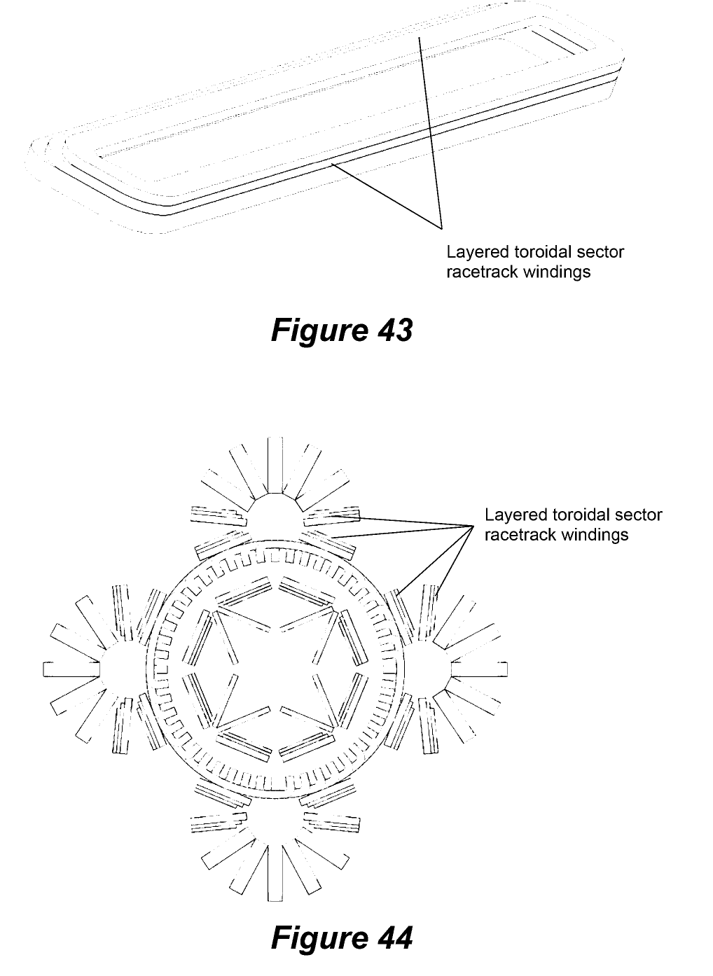

FIGS. 42 to 44 show an alternative approach to the layering of the racetracks in the vicinity of the working region/gap. Again the purpose of layering and redistributing the turns is to more evenly distribute the peak field in the toroidal windings and to improve the strength and uniformity of the field in the working region or gap. In FIG. 42, the coils have been split along their thickness and progressively reduced in width in order to more evenly distribute the peak field and to strengthen and improve uniformity of the field in the region of the current carrying windings.

In another embodiment of the toroidal style devices the creation and direction of the magnetic flux between successive poles around a cylindrical stator is accomplished using a smaller number of discrete coils. The arrangement of the smaller number of discrete coils produces a similar effect to that produced by a cylindrical Halbach array of permanent magnet material. This ‘Flux Directed’ coil construction achieves a similar effect to the arrangement of a larger number of coils in a set of toroidal sectors, in terms of containing and directing the magnetic field between successive poles, but uses a smaller amount of superconducting material.

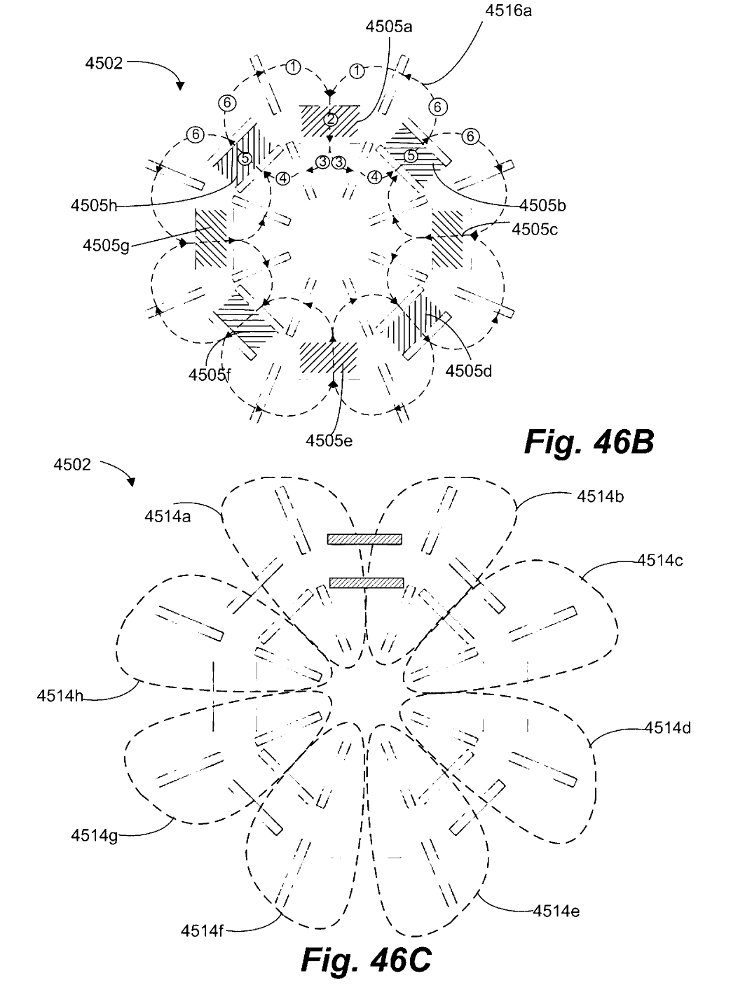

FIGS. 45 to 48 show characteristics of an embodiment of an electromagnetic device 4500. The electromagnetic device 4500 includes a gap 4504, and a flux directing assembly 4502 separated by the gap 4504 into an inner portion and an outer portion. The gap 4504 includes multiple gap regions such as gap regions 4505a, 4505b . . . 4505h (collectively referred to as gap regions 4505 and depicted in FIG. 46C). The electromagnetic device further includes a conductor array 4506 arranged in the gap 4504 to move relative to the flux directing assembly 4502. In one embodiment, the flux directing assembly 4502 may be a stator and the conductor array 4506 may be a rotor. Alternatively, the flux directing assembly may be a rotor and the conductor array may be a stator.

The conductor array 4506 has a substantially cylindrical shape. It includes one or more conductors 4510 each configured to carry current in a respective current flow direction. The gap 4504 may also be in the form of a cylindrical space. The shape of the gap 4504 may correspond with the shape of the conductor array 4506. In some embodiments, the conductor array 4506 is wound on a rotor assembly (not shown) that consists of a cylindrical structure that supports and locates the conductor array 4506. This cylindrical structure connects to a shaft (not shown) and bearing assembly (not shown) that allows the rotor to spin and for power to be delivered or taken off from the shaft and rotor assembly. The rotor windings might be supported from both ends or from one end.

As seen in FIG. 46A, the flux directing assembly is formed of multiple working elements 4518a, 4518b, 4518c, . . . , 4518h (collectively referred to as working elements 4518) and multiple redirecting elements 4520a, 4520b, 4520c, . . . , 4520h (collectively referred to as redirecting elements 4520). In the embodiment illustrated in FIGS. 45-47, each working element includes two working coils substantially aligned on opposite sides of the corresponding gap region. In the present radial embodiment, these coils are termed as an outer working coil (denoted with subscript “o”, e.g., 4518aₒ) and an inner working coil (denoted with subscript “i”, e.g., 4518aᵢ). However, in other embodiments, such as axial embodiments (see description in paragraph [0157]), the two working coils may be termed as left and right working coils, or first and second working coils, without departing from the scope of the present disclosure. Similarly, each redirecting element includes two redirecting coils substantially aligned on opposite sides of the gap 4504. In the present embodiment, these coils are termed as an outer redirecting coil (denoted with subscript “o”, e.g., 4520aₒ) and a complementary inner redirecting coil (denoted with subscript “i”, e.g., 4520aᵢ). For simplification purposes, while the inner and outer coils of the working element 4518a and the redirecting element 4520a are labelled with subscripts, the inner and outer coils for working elements 4518b-h and redirecting elements 4520b-h are not labelled in Figures with subscript “i” or “o”. The inner working and redirecting coils help strengthen and direct the magnetic field across the gap regions of the device 4500.

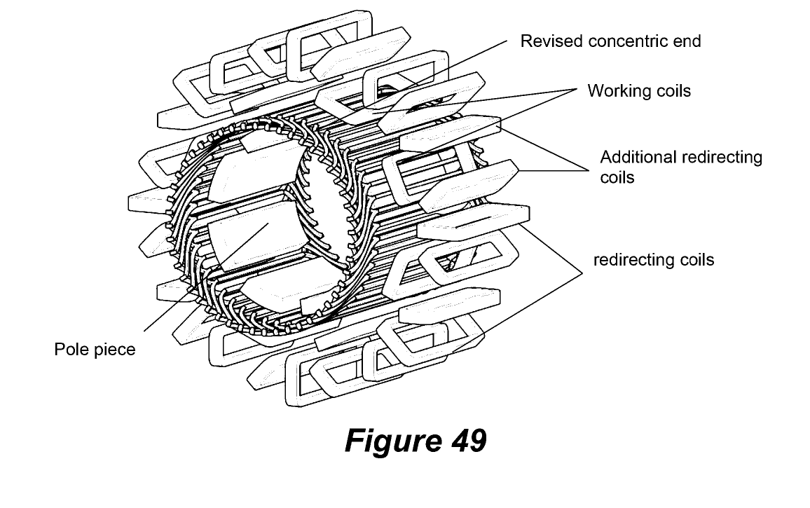

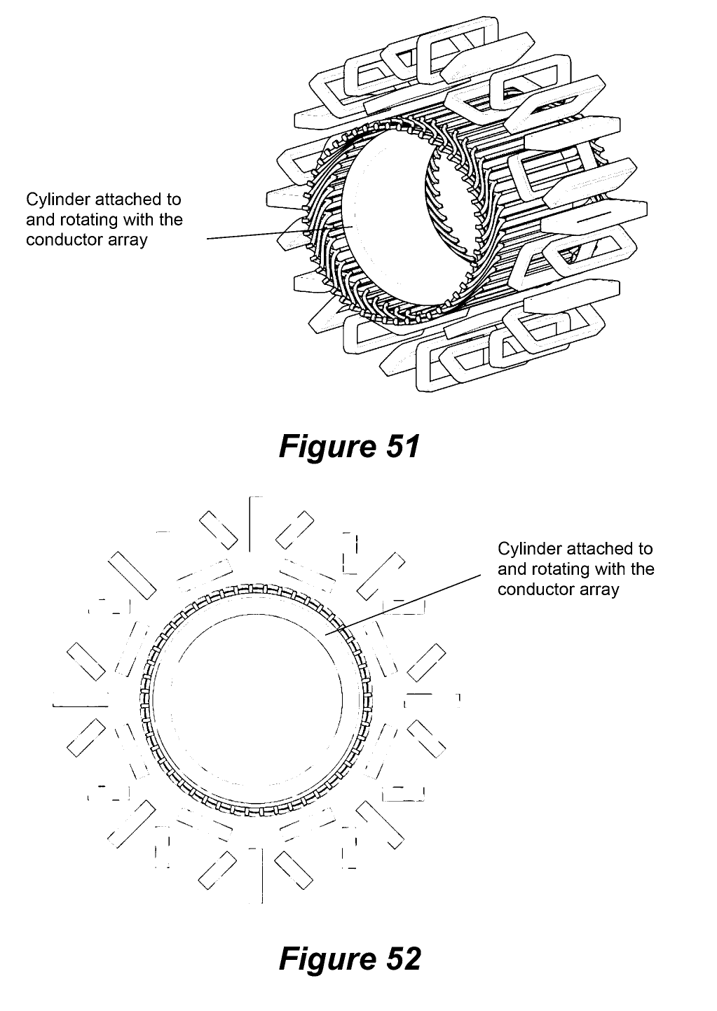

In other embodiments, the working element may include one coil on one side of the gap region and a corresponding portion of a flux guide on the opposite side of the gap region. Example flux guides include multiple pole pieces or a hollow cylinder. FIG. 49 shows an example, where the inner working coils are replaced by pole pieces, and FIG. 51 shows an example, where the inner working coils and redirecting coils are replaced by a hollow cylinder.

Similarly, the redirecting element may include a single redirecting coil on one side of the gap or multiple redirecting coils on one or both sides of the gap (as shown in later embodiments). When redirecting coils are present on one side of the gap, and not the other, portions of a flux guide on the other side may function as redirecting coils as described in detail with reference to FIG. 51.

In some embodiments, the coils of the flux directing assembly 4502 are mechanically retained in a cryostat structure, comprising first and second cryostats for the two portions of the flux directing assembly (such as the inner portion and the outer portion). The cryostat structure secures the relative locations of the inner and outer portions of the flux directing assembly and provides cooling to the superconducting coils. The conductor array may be outside the cryostats, at room temperature, in the gap 4504 between the first and second cryostats.

As seen in FIG. 46C, the flux directing assembly 4502 has multiple flux directing sections, such as sections 4514a, 4514b, 4514c . . . 4514h (collectively referred to as flux directing sections 4514) arranged adjacent to each other. Each flux directing section 4514 includes a redirecting element (e.g., 4520a in section 4514a as seen in FIG. 46B) and, in part, two working elements (e.g., 4518h and 4518a in section 4514a as seen in FIG. 46C). Each flux directing section is configured to facilitate a circulating magnetic flux path 4516a-h (as illustrated in FIG. 46B as a simplified representation of the actual underlying field pattern, an example of which is illustrated in FIG. 48) about the respective flux directing section. Each flux directing section 4514 corresponds to a pole of the electromagnetic device 4500. In this embodiment, the flux directing assembly 4502 includes eight flux directing sections or poles. That is, this embodiment includes eight working elements and eight redirecting elements. As seen in FIGS. 45-47, each pair of adjacent flux directing sections share a common working element. For example, working element 4518a is common between the flux directing sections 4514a and 4514b and the working element 4518b is common between the flux directing sections 4514b and 4514c.

Each pair of adjacent flux directing sections (for example, see flux directing sections 4514a and 4514b) is arranged about a common gap region (see gap region 4505a). Furthermore, the flux directing sections 4514 each facilitate their own circulating flux paths such that at least a part of the respective circulating magnetic flux paths cross the common gap region 4505 in a substantially similar flux direction. For example, the flux directing sections 4514a and 4514b that share the common working element 4518a (i.e., outer working coil 4518aₒ and inner working coil 4518aᵢ) direct at least part of the respective circulating magnetic flux paths across the common gap region 4505a in a substantially similar inward direction (see the magnetic flux paths of the flux directing sections 4514a and 4514b in the common gap region 4505a). Similarly, the magnetic flux paths of both the flux directing sections 4514b and 4514c are directed outwards in the common gap region 4505b, by the working element 4518b (i.e., outer working element 4518bₒ and inner working element 4518bᵢ).

In this embodiment, during operation, the flux directing assembly 4502 facilitates eight circulating flux directing paths. It will be appreciated that the number of flux directing paths is equal to the number of gap regions and flux directing sections. The magnetic flux paths of three of the flux directing sections (i.e., sections 4514a, 4514b and 4514c) will be described in detail next to illustrate how the magnetic field is directed.

As mentioned previously, the working elements are configured to direct magnetic flux into the gap regions 4505. The redirecting elements are each configured to receive magnetic flux from a working element and/or forward the magnetic flux to another working element. For example, during operation, the outer working coil 4518aₒ is configured to receive magnetic flux from outer redirecting elements 4520aₒ and 4520bₒ (dashed arrows 1 in FIG. 46B). The outer working coil 4518aₒ then directs (forward) magnetic flux towards the gap region 4505a (dashed arrow 2 in FIG. 46B). The flux leaving the gap region 4505a is received by inner working coil 4518aᵢ. The inner working coil 4518aᵢ in turn, directs (forward) magnetic flux received from the gap region 4505a towards the inner redirecting coils 4520aᵢ and 4520bᵢ (dashed arrows 3 in FIG. 46B). As noted previously, for simplification purposes, the inner and outer working and redirecting coils are not labelled in the drawings with subscripts “i” or “o”.

The inner redirecting coils 4520aᵢ and 4520bᵢ direct (forward) the magnetic flux to the inner working coils 4518hᵢ and 4518bᵢ (dashed arrows 4 in FIG. 46B), respectively. These inner working coils direct the magnetic flux into gap regions 4505h and 4505b, respectively and towards outer working coils 4518hₒ and 4518bₒ, respectively (dashed arrows 5 in FIG. 46B). Outer working coils 4518hₒ and 4518bₒ, in turn, direct the magnetic flux to the outer redirecting coils 4520aₒ and 4520hₒ and 4520bₒ and 4520cₒ, respectively (dashed arrows 6 in FIG. 46B). This continues along the flux directing assembly 4502 such that magnetic flux from a working coil is directed towards two redirecting coils and/or received from two redirecting coils.

The conductor array is arranged in the gap, where the one or more conductors allow current to flow in a direction substantially perpendicular to the magnetic field in the gap. In the case of a motor, application of such current enables relative movement of the one or more conductors around the annular gap with respect of the flux directing assembly, facilitating rotational movement. In the case of a generator, such rotational movement around the annular gap enables generation of current or voltage along the one or more conductors.

In some embodiments, the strength of the magnetic flux directed by the working elements is reinforced compared to the strength of the magnetic flux directed by the redirecting element.

By using redirecting elements to provide multiple paths for the magnetic flux to return towards common working elements, the electromagnetic devices disclosed herein can be compact by, for example, positioning adjacent flux directing sections close to each other. Furthermore, the redirecting elements aid in shaping the field profile in the gap region to improve the smoothness of the power delivery and/or reduce torque ripple. To shape the field profile for smoothness, the position, number, angle, size and/or shape of the redirecting coils can be adjusted, for example by way of trial and error and/or simulation/optimization. As in a permanent magnetic Halbach array, the perpendicular magnetic field in the gap regions can be made more sinusoidal, that is, the back-emf can have lower harmonic content or total harmonic distortion.

In some embodiments, the working elements and the redirecting elements are formed of racetrack coils. Each working element produces the bulk of the magnetic field for each magnetic pole and each redirecting element directs and reinforces the magnetic field between each of the magnetic pole. Furthermore, the redirecting element racetrack coil is configured to direct the magnetic flux through the coil in a direction that is tangential to the rotation of the rotor 4506.

It will be appreciated that in this embodiment, the flux directing assembly is illustrated with eight poles. However, in other embodiments, the flux directing assembly 4502 may have more or fewer poles without departing from the scope of the present disclosure.

FIG. 48 shows a magnetic field plot of the electromagnetic device of FIGS. 45-47.

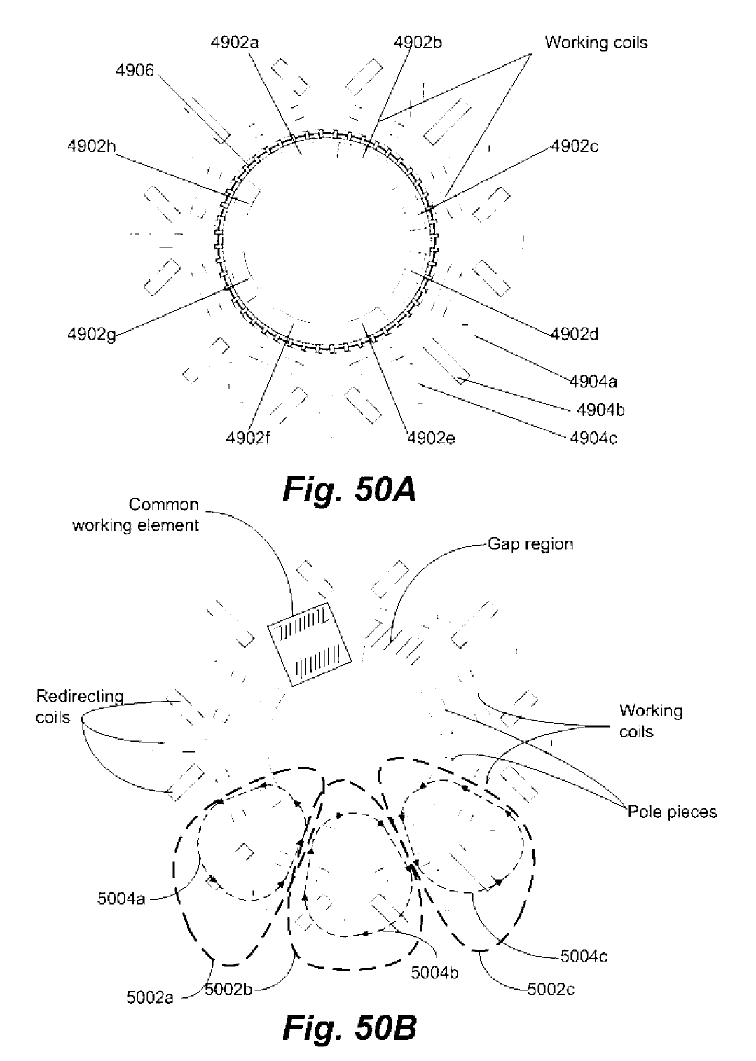

FIGS. 49, 50A and 50B show a another embodiment of the present disclosure in which the inner set of working coils are replaced by a flux guide in the form of pole pieces 4902a-h, thereby reducing the overall complexity of the motor/generator. The pole pieces may be made of a ferromagnetic material such as steel, or a paramagnetic material. Furthermore, in this embodiment, the redirecting element includes three outer redirecting coils 4904a, 4904b, and 4904c placed between adjacent outer working coils. Air gaps between the pole pieces replace any inner redirecting coils by allowing flow of magnetic flux. The additional outer redirecting coils are configured to further direct, contain and reinforce the magnetic field. These additional coils 4904a, b, and c may also be formed of racetrack coils.

In this embodiment, the end windings of the conductor array 4906 are ‘diamond shaped’ rather than bedstead shaped such that they do not extend beyond the inner and outer radial constraints of the rotor body. This allows the rotor to fit cleanly through the clear bore of the device. However, it will be appreciated that bedstead shaped end windings may also be utilized with this embodiment without departing from the scope of the present disclosure.

FIG. 50B illustrates three of the flux directing sections of the flux directing assembly (i.e., flux directing sections 5002a, 5002b, and 5002c) and their respective magnetic flux paths (5004a, 5004b, 5004c). As seen the inner steel pole pieces 4902 are configured to receive magnetic flux from (or direct magnetic flux to) the outer working coils (across the gap regions) and configured to redirect the magnetic flux to (or from) adjacent inner steel pole pieces.

FIGS. 51 and 52 show a further embodiment of the present disclosure, where the set of steel pole pieces are replaced by a cylindrical flux guide. The flux guide may be formed of a series of laminated metal sheets made from material such as steel or any other ferrite based material, which is of a low core loss variety. The cylindrical flux guide may be mechanically coupled to and rotate with the current carrying winding assembly (rotor 5106). This embodiment can simplify the construction of the rotating componentry of the motor/generator. Alternatively the central cylindrical flux guide can remain stationery and separate from the current carrying windings.

As noted previously, the portions of the cylindrical flux guide that are directly opposite the outer working coils function as part of the corresponding working element, whereas the remaining portions of the cylindrical flux guide function as part of the redirecting elements.

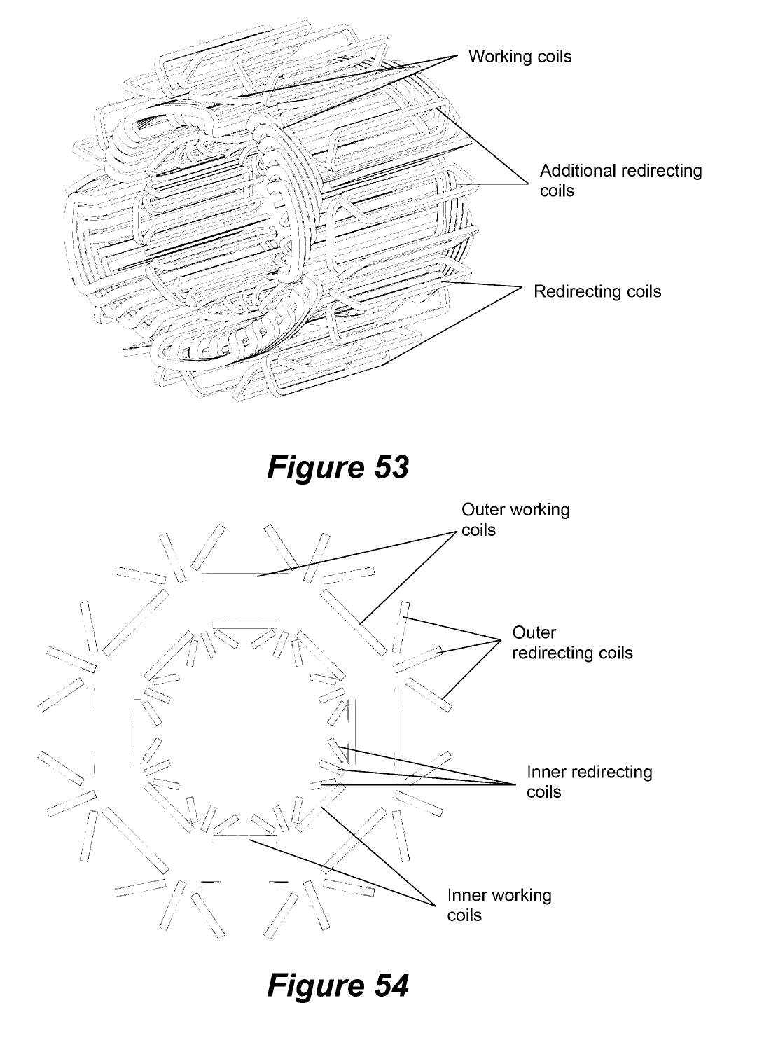

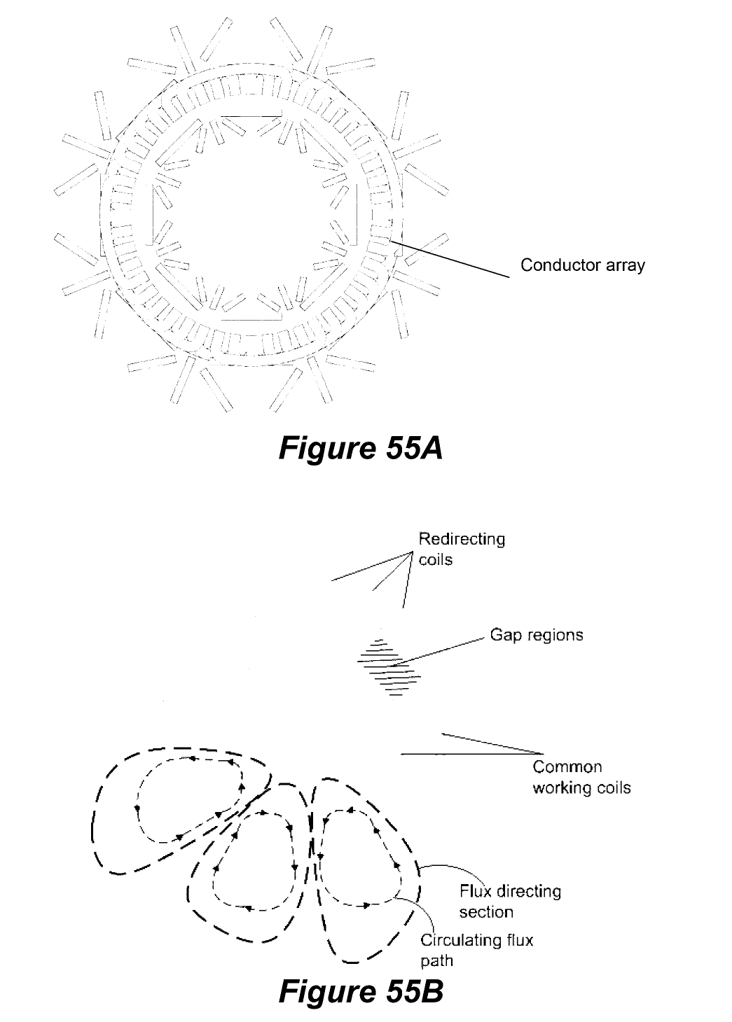

FIGS. 53, 54, 55A and 55B show another embodiment of the electromagnetic device in which the redirecting elements, each, include additional inner and outer redirecting coils between the working elements. FIG. 55B illustrates the flux directing sections and corresponding flux paths of the flux directing assembly.

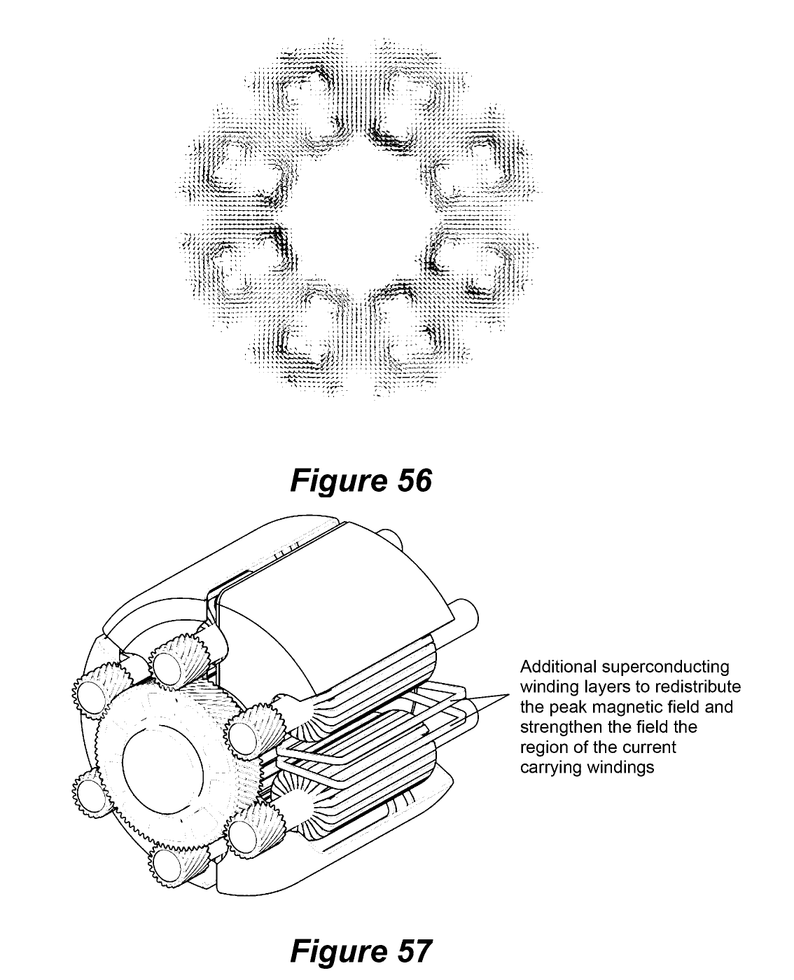

FIG. 56 shows a magnetic field plot of the electromagnetic device of FIGS. 53-55. Similar to the previous embodiment, the electromagnetic device in this embodiment includes eight flux directing sections, each facilitating a circulating flux path.

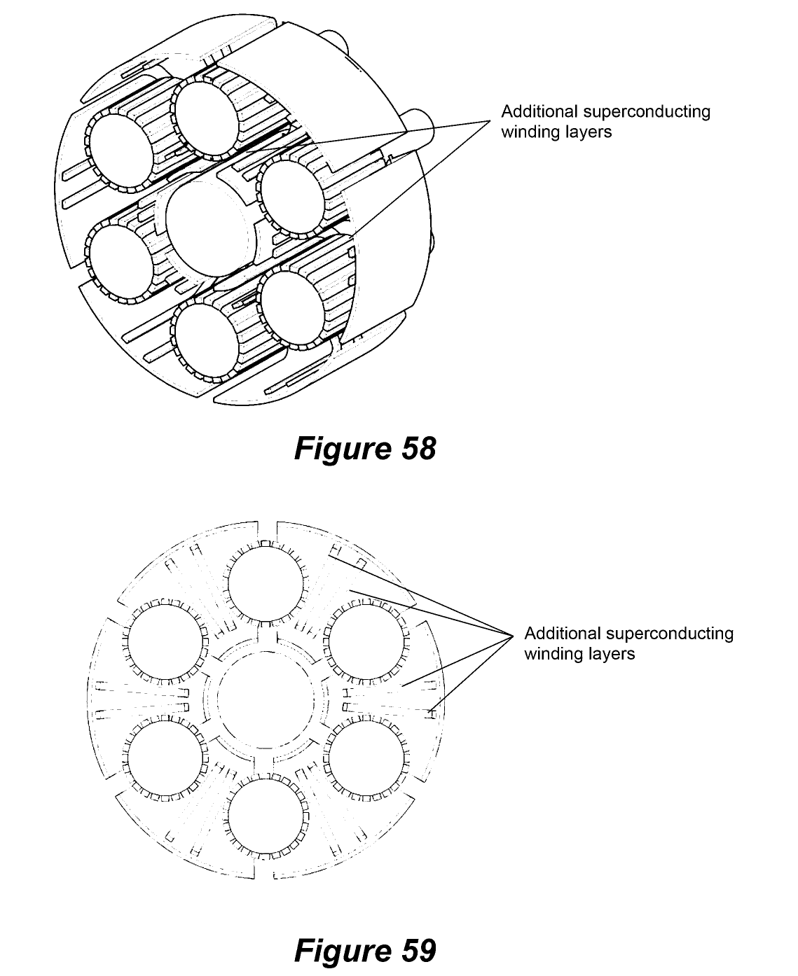

FIG. 57, FIG. 58 and FIG. 59 show a multi-rotor geared toroidal motor/generator that employs the layering approach seen in the Star Toroidal variation of FIG. 40 wherein the toroidal sectors have additional layers of superconducting windings located in between the rotor assemblies in order to reduce and more evenly distribute the peak field on the superconducting toroidal windings, as well as increasing the strength and uniformity of the superconducting windings in the region of the rotor assemblies. This results in greater power from the motor/generator and more efficient use of the superconducting wire.

### Flux Directed Permanent Magnet Machines:

The embodiments disclosed concern devices that use flux directing assemblies having arrays of permanent magnets that are magnetised in such a manner so as to direct magnetic field in a succession of working elements around a gap or region. Within this gap region a set of current carrying windings are placed such that energising the current carrying windings results in the relative rotation between the magnetic array and the current carrying windings, thereby resulting in the conversion of electrical power to mechanical power. The reverse scenario, where the application of mechanical power to the permanent magnet array results in the generation of electrical current and power in the current carrying windings, is also applicable.

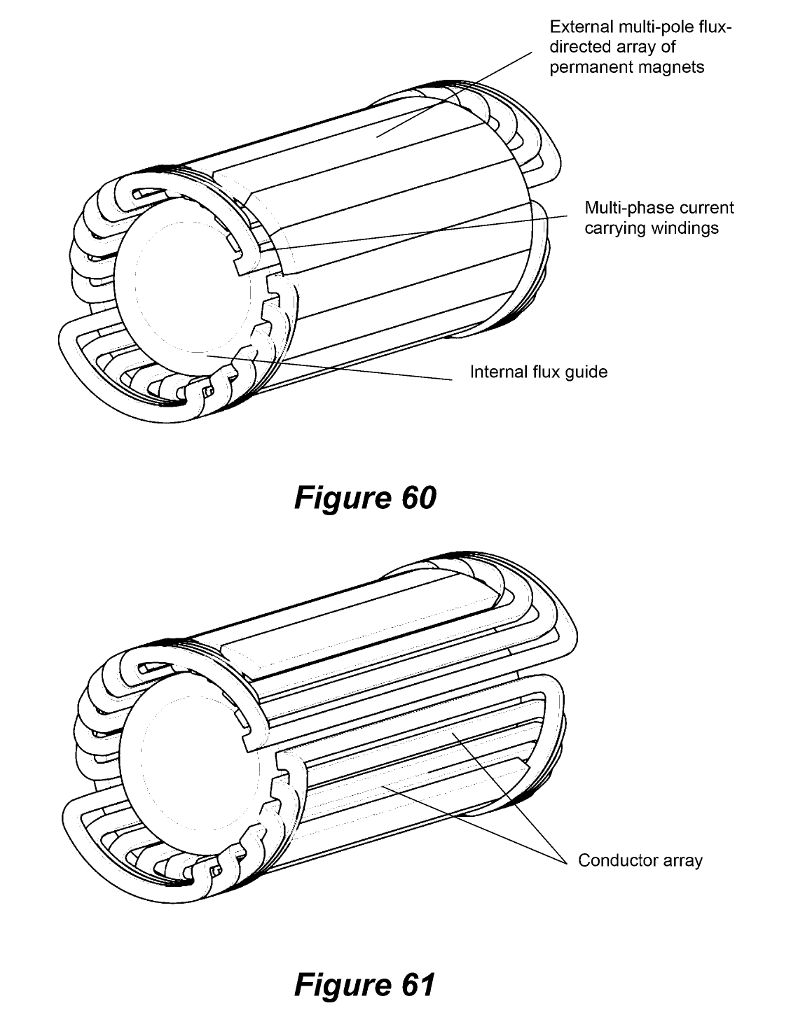

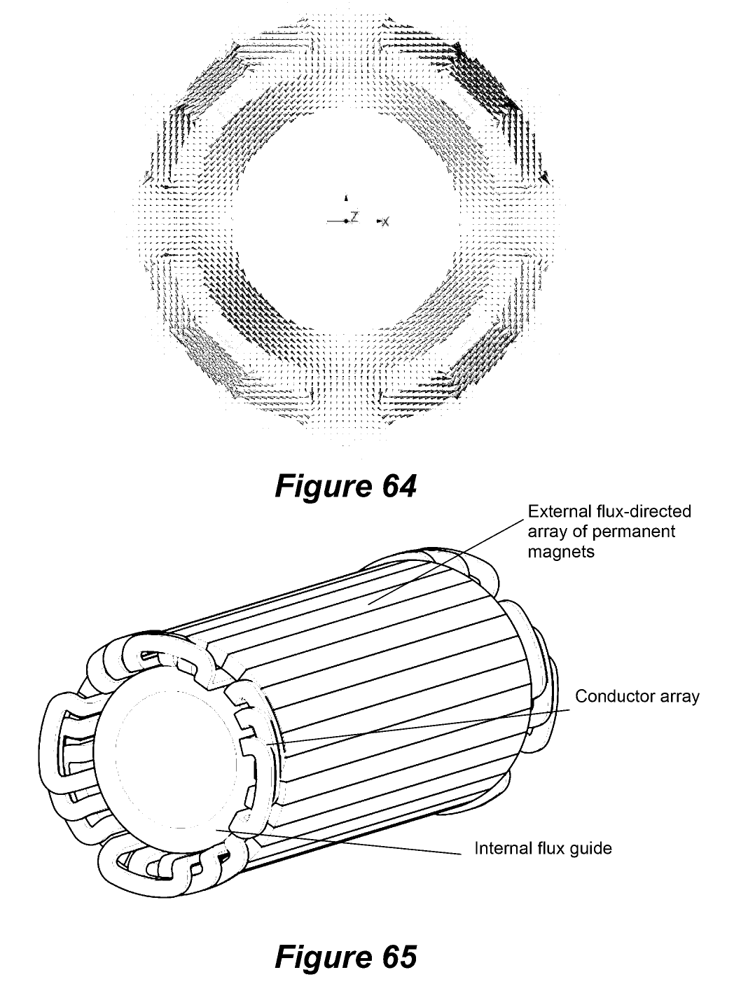

FIG. 60 to FIG. 63 show a version of these permanent magnet flux directed motor/generators that has an outer array of permanent magnets. The array of permanent magnets is comprised of a series of sectors that have a sequential direction of magnetisation such that they create an internal Halbach cylinder. This functional magnetisation is the same as that previously disclosed for the Halbach cylindrical magnetic gearboxes. Generally, a higher number of individually magnetized array elements results in a more uniform field in the working region but the benefit of this more uniform field must be weighed against the increased complexity that assembling a higher number of individually magnetized array elements entails. In the embodiment shown, 4 array segments are used to create one flux directing section with the relative directions of magnetization indicated in FIG. 63. The resultant magnetic field plot shown in FIG. 64. However, more or fewer segments may be utilised to create flux directing sections as required. The radially directed magnet segments form the working elements of the flux directing section, whereas the remaining segments form the redirecting elements.

Other features of this embodiment include a set of multi-phase current carrying windings and an internal steel flux guide that draws the magnetic field created by the outer magnetic array across the working gap. In one embodiment the flux guide is constructed from laminated, low core loss material and is attached to the current carrying windings. In this embodiment the windings and internal flux guide remain stationary and the outer magnet array rotates.

It will be appreciated that in other embodiments the device may have an inner array of permanent magnets and an external steel flux guide that draws the magnetic field created by the inner magnetic array across the working gap.

In an alternative embodiment of the device shown in FIG. 60, the internal steel flux guide is not attached to the current carrying windings and rotates with the permanent magnet array. In yet a further embodiment the current carrying windings rotate and the permanent magnet array or the permanent magnet array and the internal steel flux guide are stationary with the current transports to and from the windings via sliding electrical contacts or slip rings.

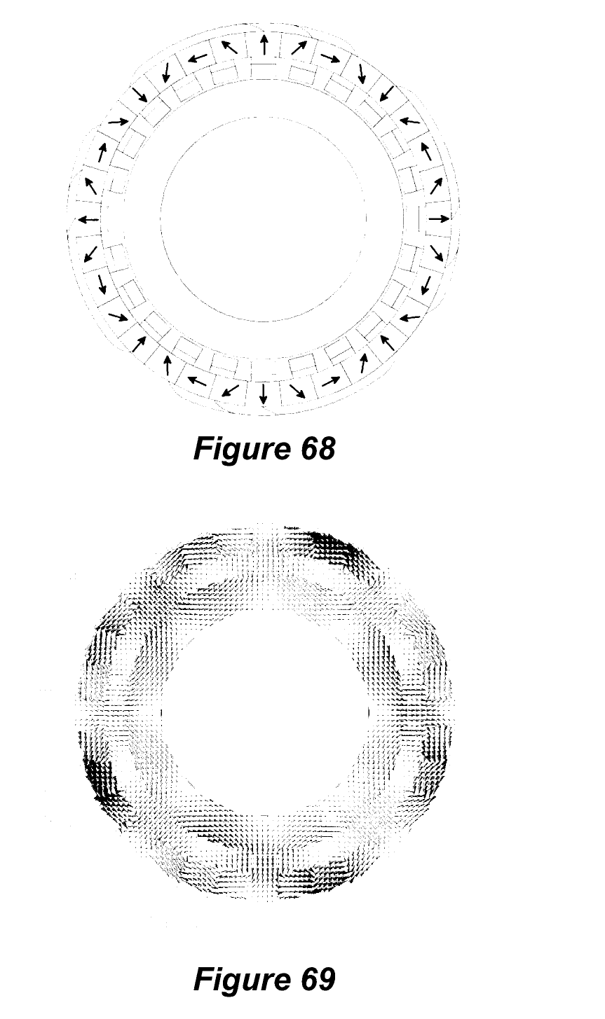

FIGS. 65 to 67 show an embodiment of the flux directed permanent magnet machine that is an 8 pole device. This embodiment demonstrates how the construction of this type of device can be extended to any number of magnetic poles. FIG. 68 and FIG. 69 show the relative directions of magnetization and a magnetic field plot of the embodiment.

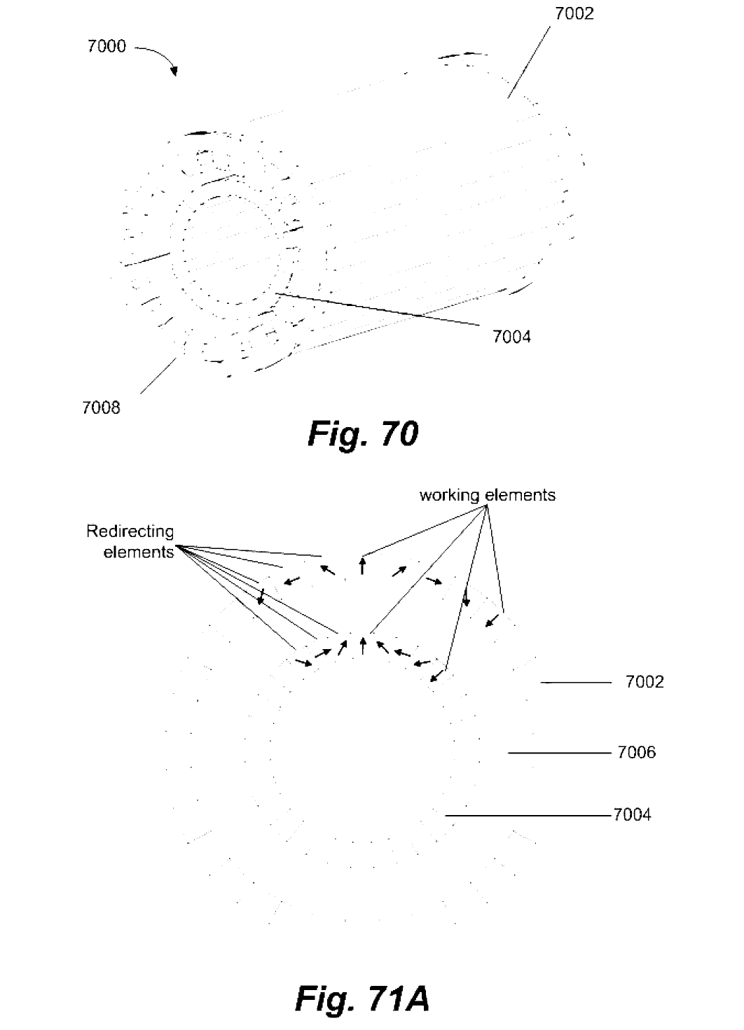

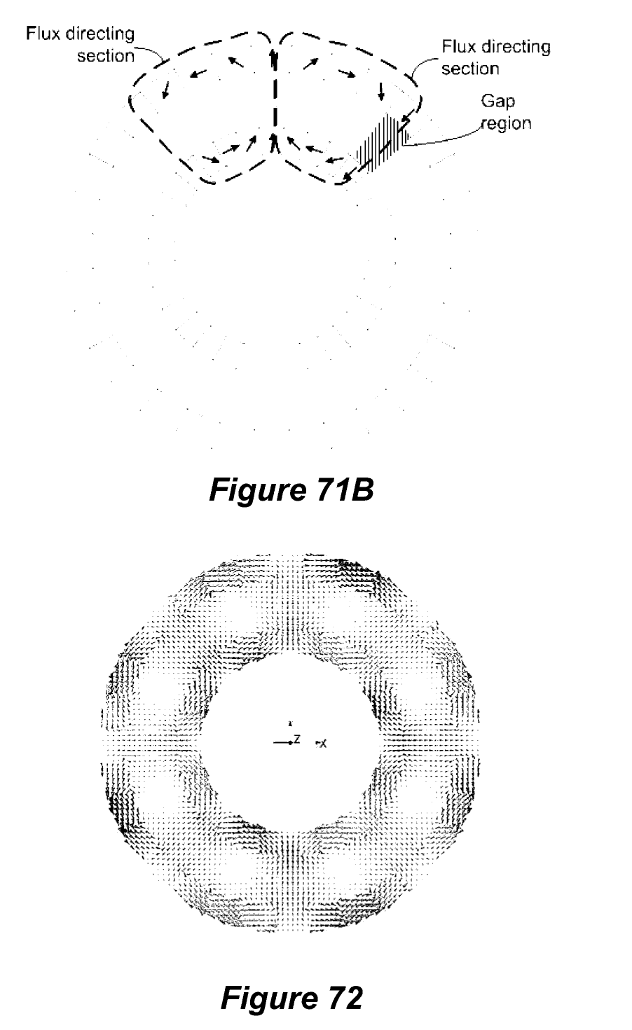

FIGS. 70 and 71 illustrate an exemplary permanent magnet device 7000, having a pair of coaxial permanent magnet arrays 7002 and 7004 with a gap 7006 therebetween. The arrays of permanent magnets 7002 and 7004 include a series of sectors that have a sequential direction of magnetisation such that they create a Halbach array. In the embodiment shown, four array segments are used to create one flux directing section (as seen in FIG. 71B) with the relative directions of magnetization indicated in FIGS. 71A and 71B. The resultant magnetic field plot is shown in FIG. 72. In alternate embodiments, more or fewer segments may be used to create a flux directing section.

In this embodiment, the windings 7008 remain stationary whereas the flux directing assembly rotates. It will be appreciated that the alternative (i.e., stationary flux directing assembly and rotating conductive windings) is also considered within the scope of the present disclosure.

The elements of the inner and outer Halbach arrays are magnetized such that the two permanent magnet cylinders are aligned to create a strong magnetic field in the gap region where the current carrying windings sit. FIG. 71 shows the repeating pattern of magnetization used and FIG. 72 shows the resultant field plot.

As seen in FIG. 71B, the permanent magnet sections that are magnetized in the radially outward or inward directions form the working elements, whereas the remaining permanent magnet sections form the redirecting elements of the flux directing assembly. The array directs magnetic flux in the direction shown by the arrows in FIGS. 71 and 71B. Magnetic flux is directed through the gap regions between the working elements (i.e., the outer and inner radially magnetized permanent magnet sections) and redirected back to the next working element by the permanent magnet sections in between.

It should be appreciated by the skilled person in the art that, while the “radial” embodiments illustrated in FIGS. 45, 49, 51, and 53 have the magnetic flux flowing across the gap in the radial direction, their description with minor modifications may be applicable to “axial” embodiments, where the working magnetic flux flows in the axial direction across the gap. Alternatives provided by radial and axial embodiments have been described, for example, in the applicant's prior publications, such as PCT application no. PCT/AU2015/050333 published as WO2015192181, the relevant description of which is incorporated herein by reference.

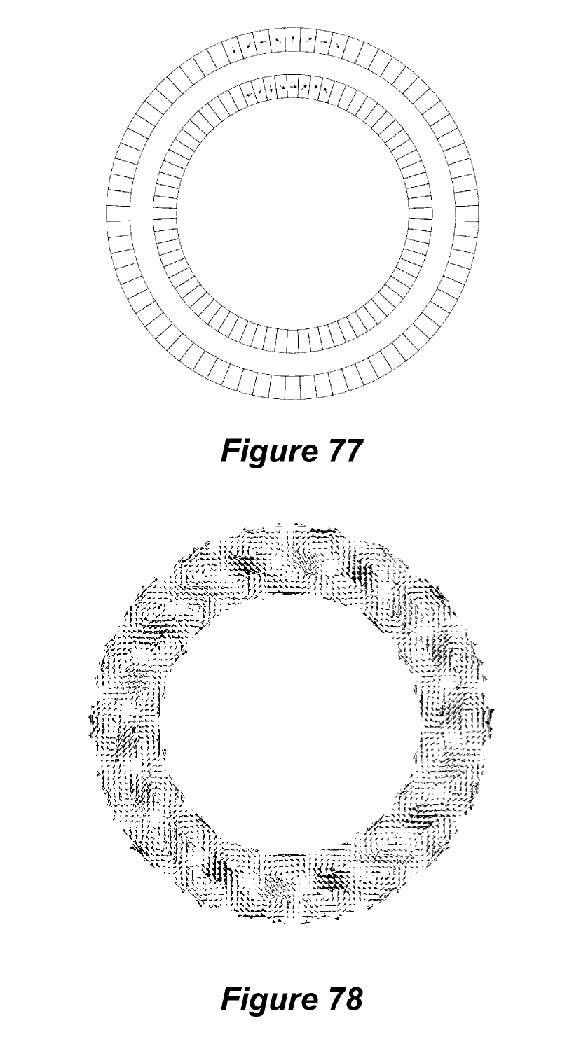

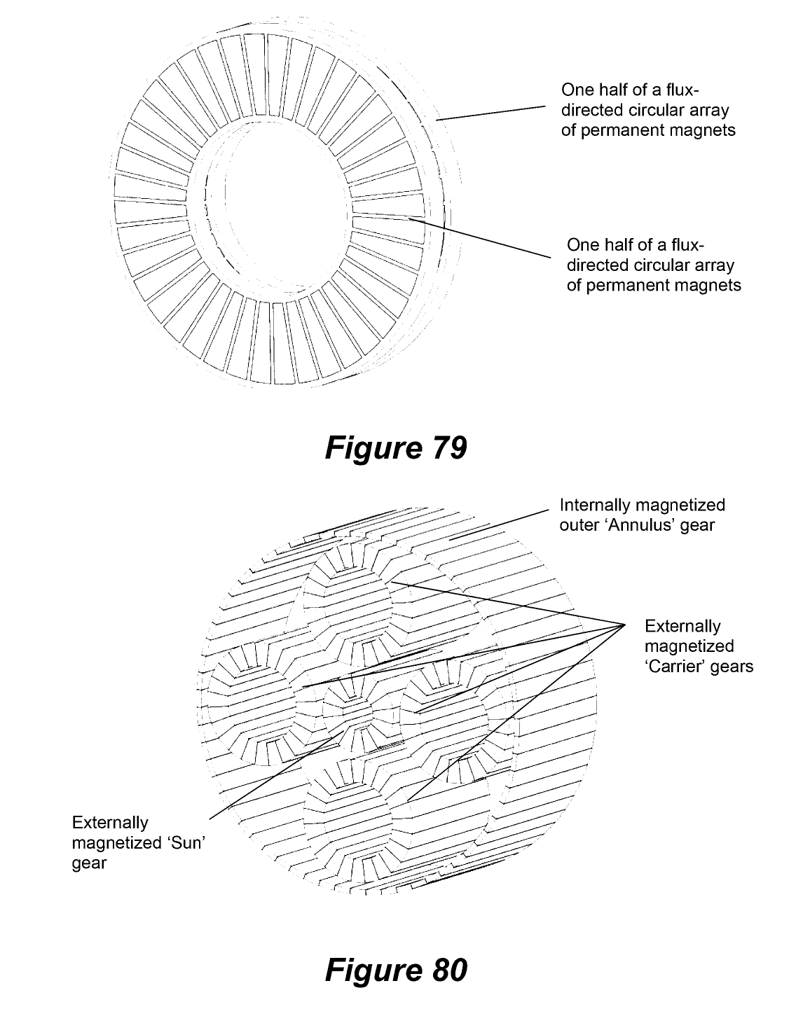

Furthermore, as described below for arrangements involving Halbach arrays, FIG. 79 illustrates an axial equivalent of a radial embodiment illustrated in, for example, FIG. 77.

A further variation on the disclosed embodiments involves the use of a layer of backing steel on the outer side of the external permanent magnet array (or additionally on the inner layer of the internal flux directed permanent magnet array). This backing steel helps to contain and strengthen the magnetic field within the devices thereby increasing the power level of the device.

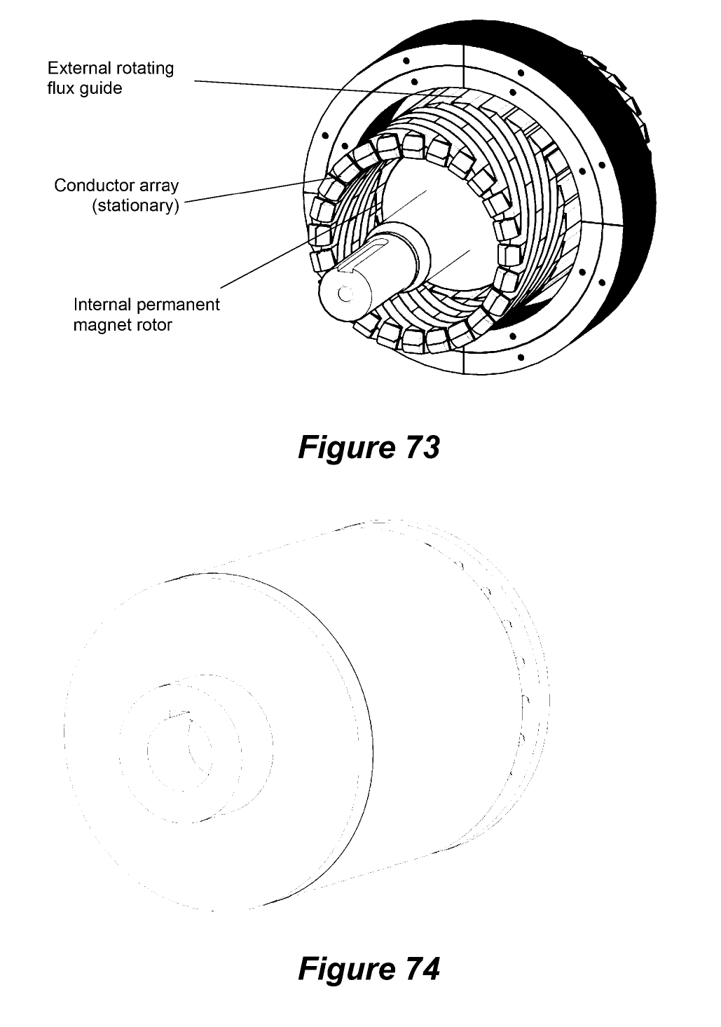

FIG. 73 shows a 2 pole permanent magnet motor/generator that has an internal permanent magnet rotor. In the variation depicted the outer steel flux guide is detached from the current carrying windings and spins in concert with the rotating permanent magnet. This is in contrast with previously disclosed devices wherein the steel flux guides are attached to the current carrying windings.

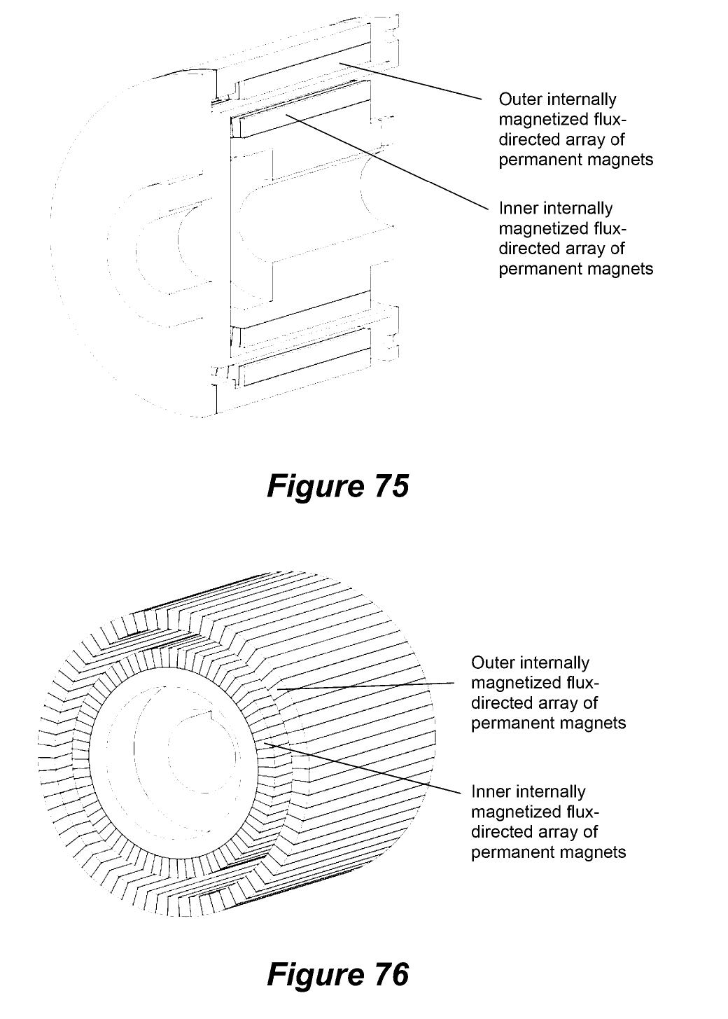

FIG. 74 and FIG. 75 show the physical construction of a magnetic torque transfer coupling that is based on the interaction of the magnetic field created by an externally magnetized Halbach cylinder mounted inside an internally magnetized Halbach cylinder. When a torque is applied to one half of the coupling a relative slip occurs between the inner and outer magnetic cylinders until the point that the torque between the two halves equalises thereby allowing contactless transmission of torque. The general arrangement and magnetization of the inner and outer cylindrical magnetic arrays is shown in FIG. 76 and FIG. 77. A sectional field plot of the coupling is shown in FIG. 78.

It will be clear to a person skilled in the art that the torque coupling described wherein the predominant direction of the interacting magnetic fields is along the radial direction of the device, that an equivalent device could be constructed wherein the predominant direction of the interacting magnetic fields is along the axial direction of the device. Such an axial flux device is shown in FIG. 79. The pattern of magnetization of the two halves of the axial torque coupling is the same as that employed in the previously disclosed axial Halbach gearing system.

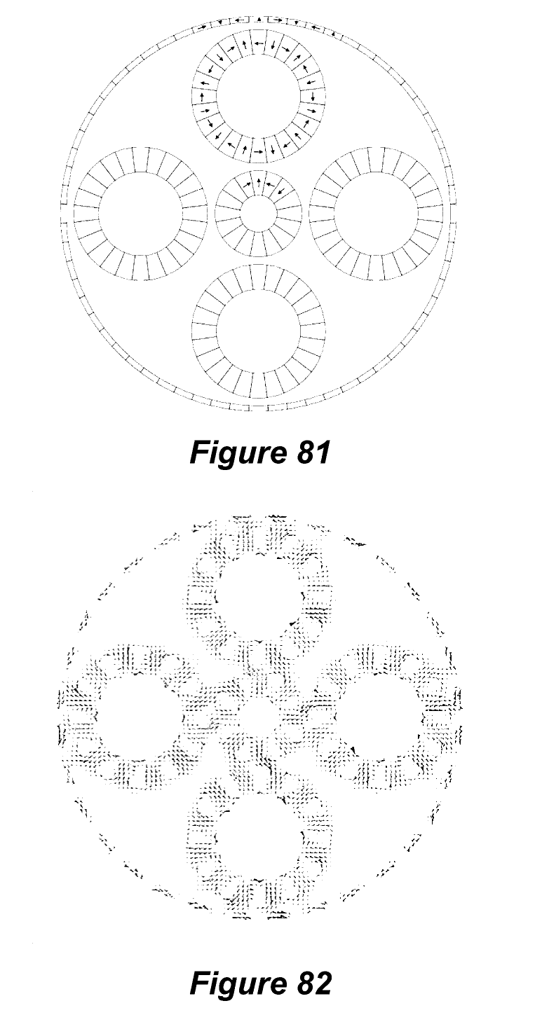

In a further variation to the previously disclosed magnetic gearbox that featured multiple input/output shafts feeding torque to or from a single secondary shaft, the externally magnetized ‘planet’ gears can further transmit torque to a central ‘sun’ magnetic gear that is also constructed as an externally magnetized Halbach cylinder. The device effectively becomes a magnetic epicyclical gearbox that has no physical contact between the different torque transmitting faces of the device. Similar to a traditional toothed contact epicyclical gearbox there is a central ‘sun’ gear formed from an externally magnetized Halbach cylinder, several externally magnetized ‘carrier’ gears similar to the previously disclosed planetary magnetic gears and an internally magnetized annulus gear that surrounds the entire assembly. An embodiment of this type of epicyclical magnetic gearbox is shown in FIG. 80 and FIG. 81. A sectional field plot of all the components interacting is shown in FIG. 82.

The ratio of the device is a function of the radius and number of magnetic poles (magnetic teeth) of each of the element in the gear and is also dependant on which elements (sun, annulus and carrier assembly) form the input and output of the gear and which element is held stationary. In a typical embodiment the sun and annulus gears form the input and output with the carrier gear assembly held stationary allowing for a relative step-up or step down of the speed or torque. This particular embodiment should not be seen as limiting potential applications and choice of inputs or outputs. The calculation of ratios for epicyclical gearboxes is well known to persons skilled in the art.

The limitation of the torque that can be transmitted is principally determined by the first interaction between the sun gear and the carrier gears. In order to make the most effective use of the magnetic material the annulus should be sized such that it's slipping point or maximum available torque is similar to that of the interaction between the sun and carrier gears.

In all of the permanent magnet devices shown where the background field is created by flux directing or Halbach style arrays of permanent magnets—these arrays are constructed from a number of discretely magnetized elements. The embodiments disclosed typically use 2 or 4 elements or discrete directions of magnetization per pole for clarity. It would be obvious to a person skilled in the art that a larger number of constituent elements could be employed and that as a larger number of discrete magnetization directions are employed, the more that the array approaches ‘ideal’ Halbach functional magnetization. These embodiments should not been seen as limiting the number of constituent elements of the flux directed array or the directions of magnetization of these constituent elements that are employed.

Many of the devices (motors, generators, couplings and gearboxes) disclosed have been shown as radial flux machines. It will also be clear to a person skilled in the art that conceptually, these devices could readily be constructed as axial flux machines and that such axial flux machines may have benefit in particular applications.

A further variation on the previously disclosed Flux Directed permanent magnet motors and generators employs an externally magnetised inner Halbach array of permanent magnetic material as the rotor that is surrounded by a set of current carrying windings and an outer laminated steel shroud or flux guide. The primary benefit of having an internal permanent magnet rotor is that the torque to and from the generator/motor can be readily delivered/extracted to or from the device via a central shaft. It is also easier to extract or deliver this torque at both ends of the device rather than at one end.

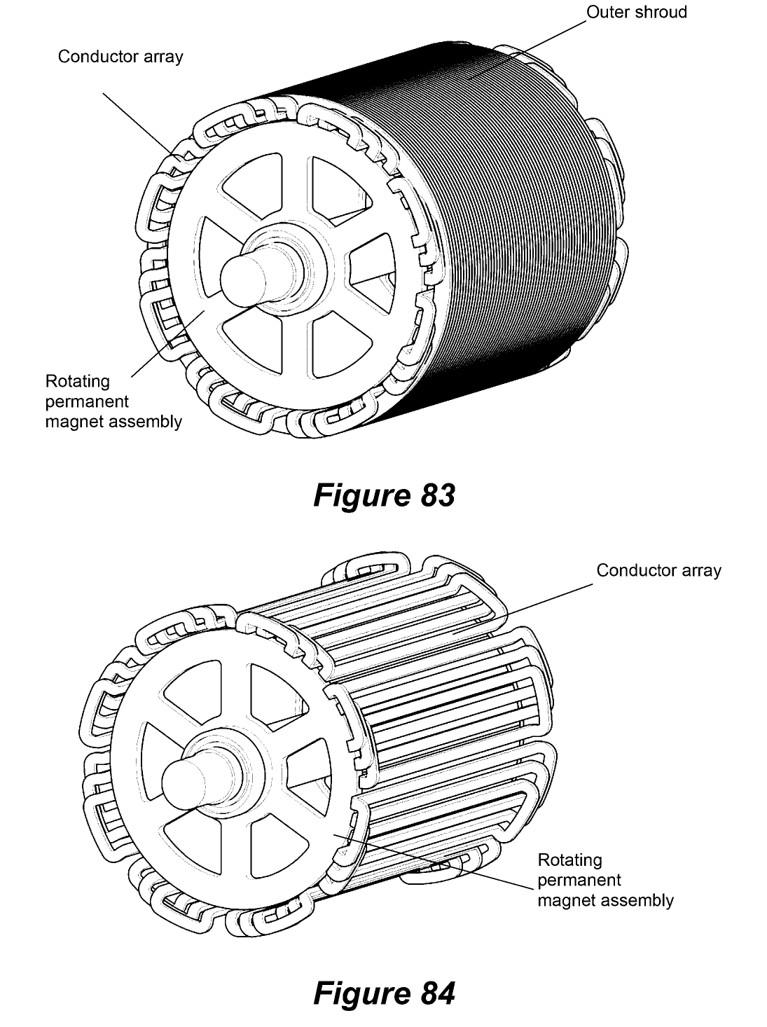

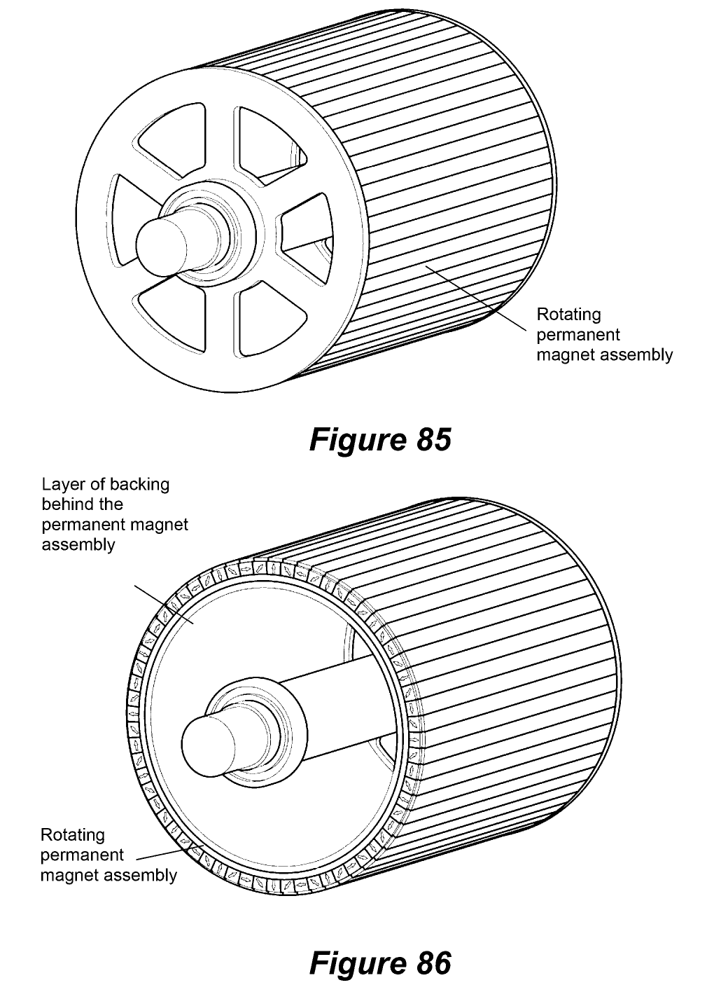

FIG. 83 to FIG. 86 shows a embodiment of a flux directed permanent magnet device with an internal permanent magnet rotor. In this embodiment the outermost layer of the device is the laminated steel shroud, to which the current carrying windings are attached on the inside of the cylindrical shroud. The embodiment shown is a 16 pole devices but the principles and improvements that are disclosed are applicable to devices of any pole count. In FIG. 85, this assembly rotates with multi-phase current carrying windings and the laminated outer steel shroud remain stationary.

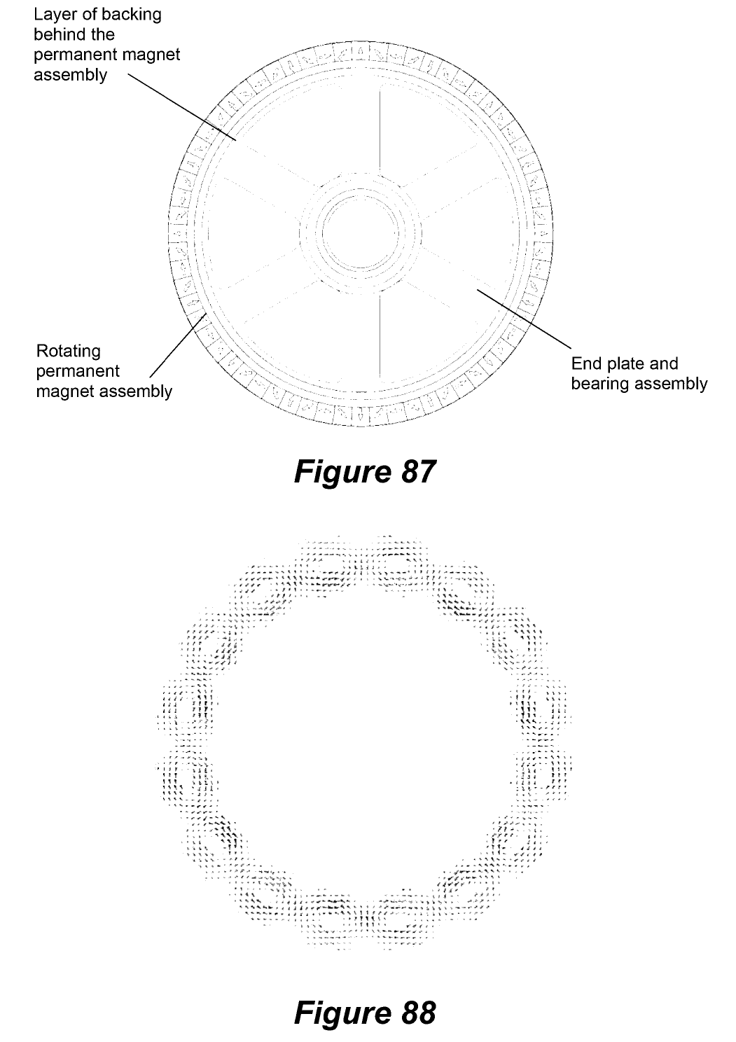

An important variation is highlighted in FIG. 86 and FIG. 87 where the permanent magnet array that creates the internal Halbach cylinder has backing layer of steel that strengthens and reinforces the directed magnetic field created by the array. One observation is that the required thickness of steel to achieve maximum field reinforcement is less for devices that have higher pole counts. FIG. 88 shows a magnetic field plot of the embodiment of FIG. 83.

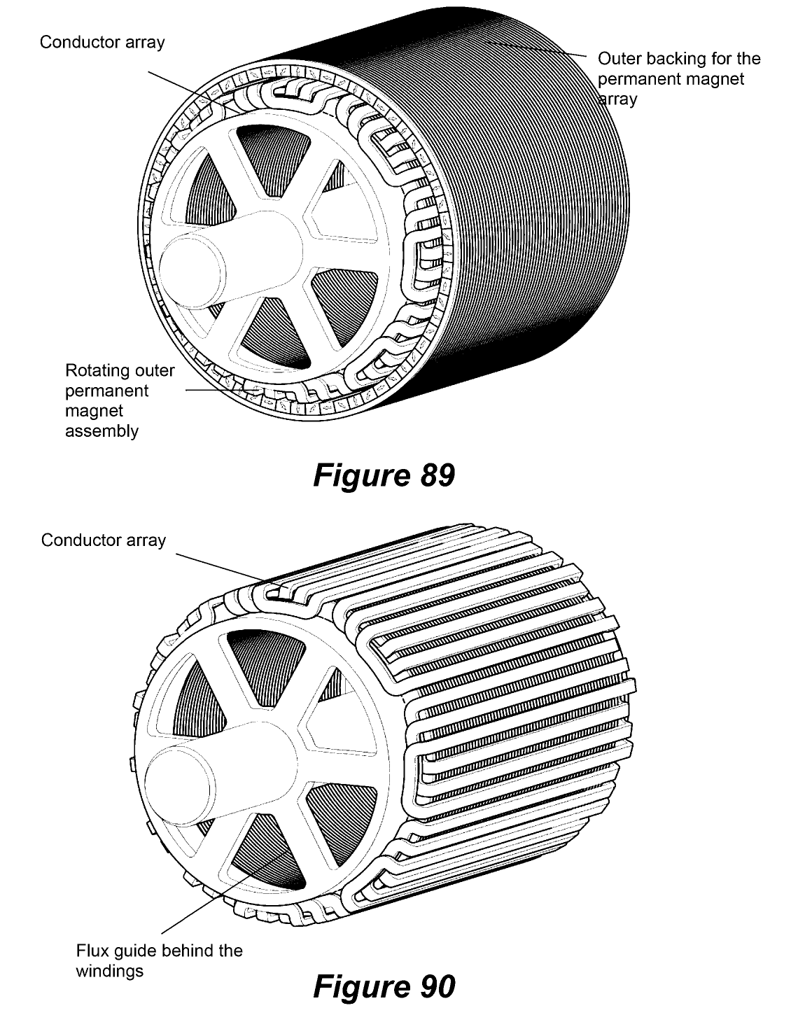

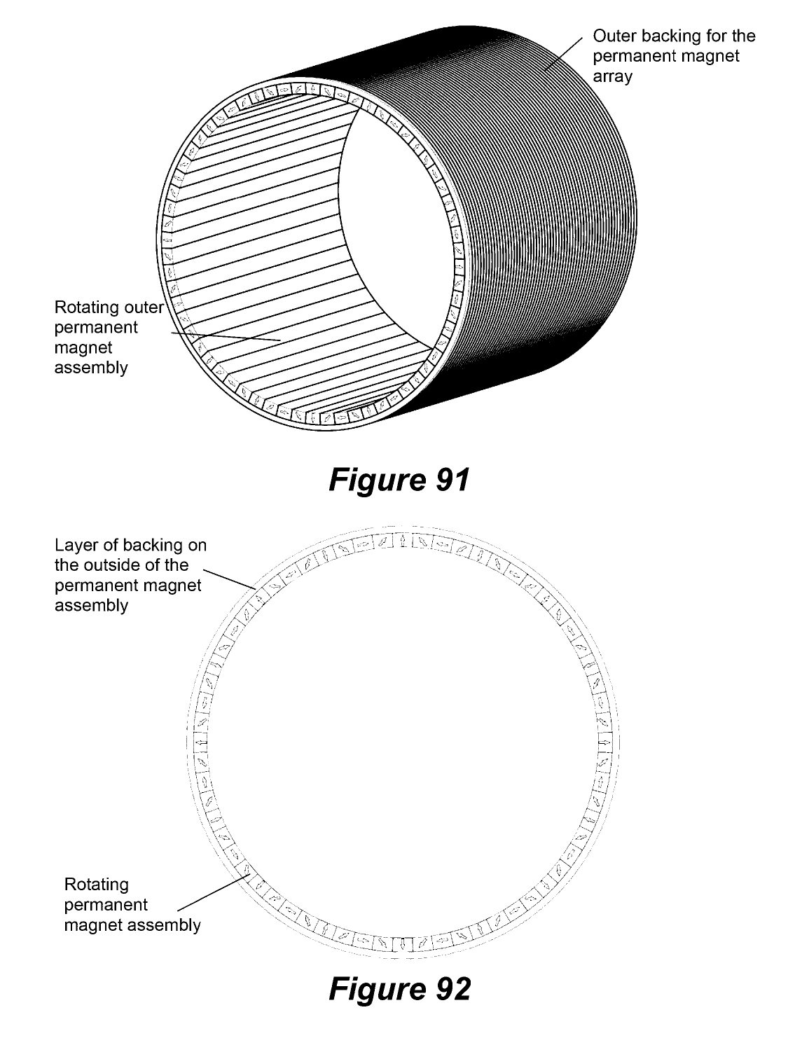

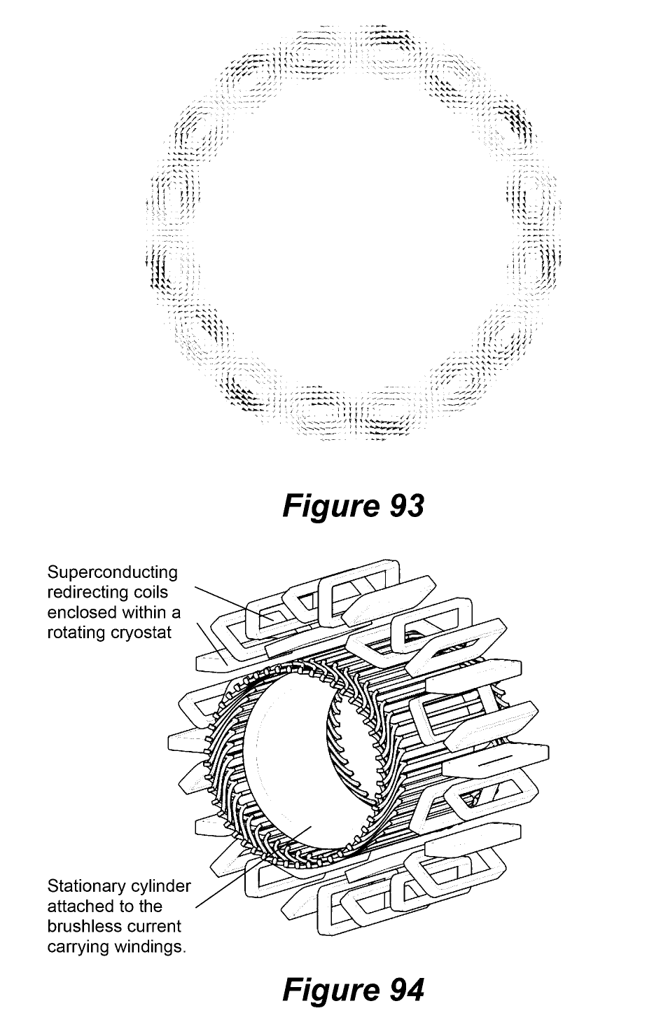

It is important to note that the use of this additional backing steel on the opposite side of the permanent magnet array to the side where the current carrying windings are located has previously been disclosed for devices that employ an internally magnetised external permanent magnet array. A 16 Pole embodiment that uses an external permanent magnet rotor with backing steel is shown in FIG. 89 to FIG. 93.

For both embodiments shown in FIG. 83 and FIG. 89 the current carrying windings could rotate with the current delivered via brushes and the permanent magnet arrays remaining stationary.

### Flux Directed Superconducting Machines:

FIG. 94 shows a Superconducting Flux Directed machine similar to that previously disclosed in FIGS. 51 and 52. This particular embodiment has the multi-phase current carrying windings attached to a cylindrical back flux guide made from laminated steel. In this embodiment the current carrying windings and back steel remain stationary while the superconducting coils that make up the flux directing assembly are contained within a rotating cryostat and rotate around the windings.

Based on the present disclosure, it would be obvious to a person skilled in the art that the superconducting coils from any of previously disclosed superconducting flux directed or star toroidal machines could be contained within a rotating cryostat and be made to rotate in relation to a set of stationary current carrying windings thereby removing the need for slip-rings or brushes to transfer power to or from these current carrying windings. This approach could be readily applied to devices that employ inner and outer star toroidal/flux directing coils as well as those that employ steel pole pieces that would rotate in concert with the rotating cryostat.

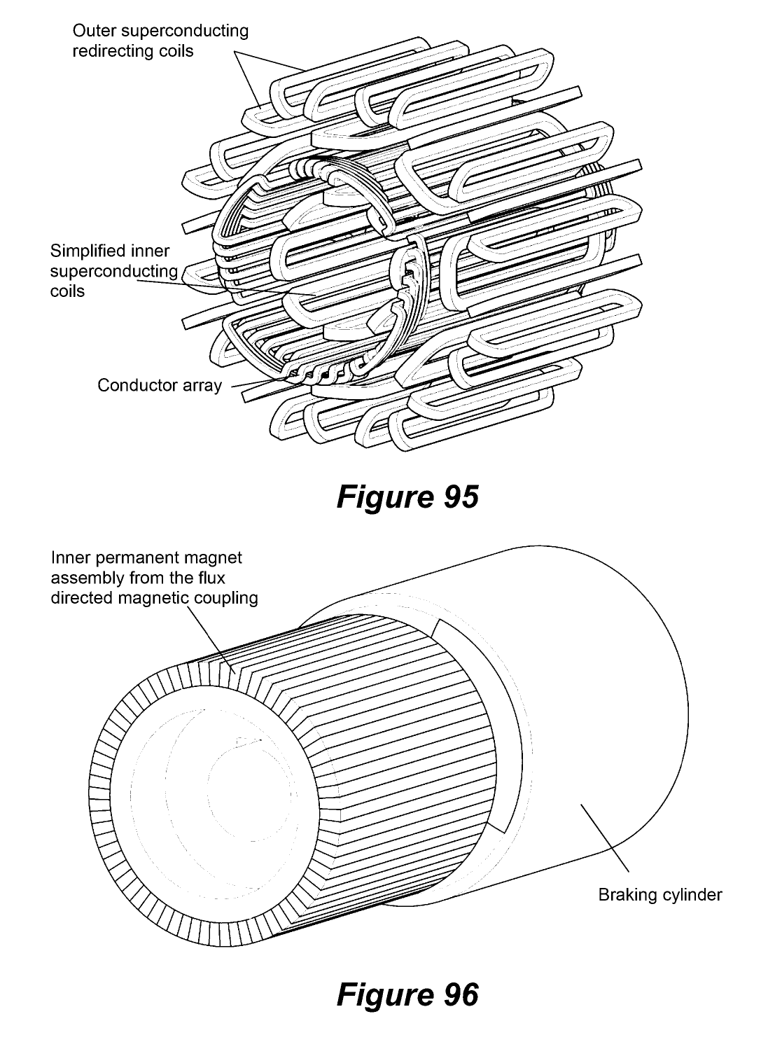

In yet a further embodiment of the Flux Directed Superconducting machines the inner flux directing coils can be simplified to a single racetrack coil per pole of the device. This variation is well suited to smaller devices where space in the internal bore for a cryostat is at a premium. An example of this embodiment is illustrated in FIG. 95. This type of simplified internal coil assembly is better suited to smaller scale devices where space in the internal bore is at a premium.

### Flux Directed Magnetic Couplings:

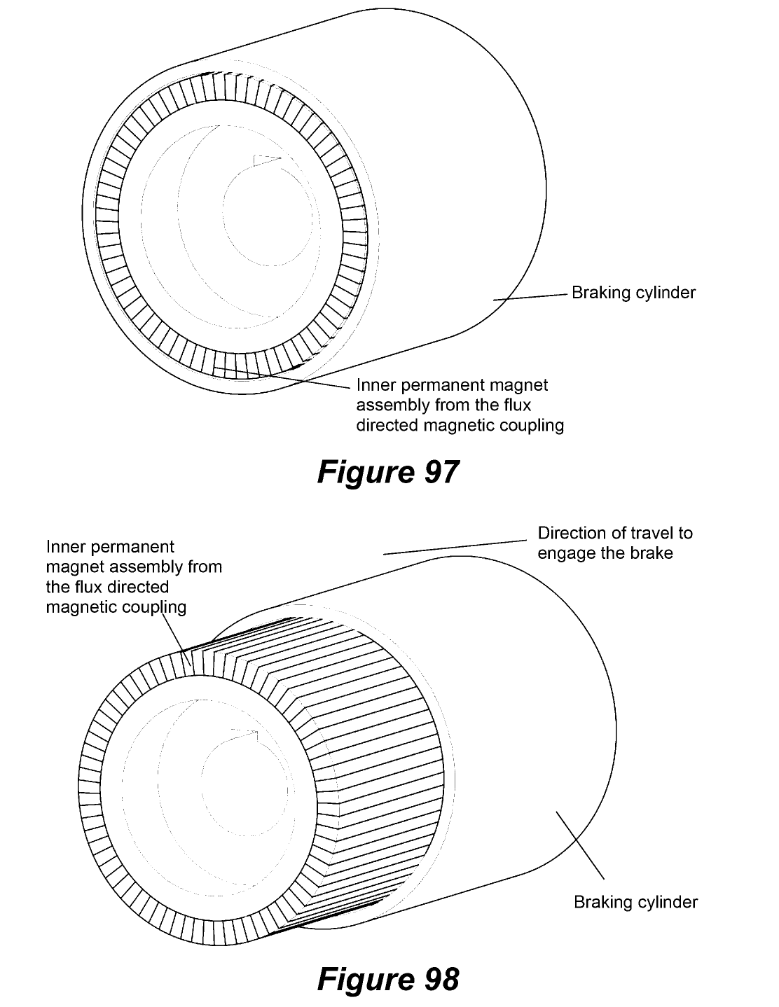

In a further addition to the previously disclosed Flux Directed magnetic coupling, an additional mechanism is included that allows the coupling to be braked. In one embodiment this brake consists of a stationary cylinder of conductive material that is introduced into the gap region between the inner and outer magnetic cylinders. If the cylinder is made from an electrically conductive material then the changing magnet field seen by the cylinder induces eddy currents in the cylinder that oppose this change in magnetic field. This results in a drag torque or braking effect on the rotating members of the coupling. The arrangement and operation of the braking assembly is illustrated in FIG. 96, FIG. 97 and FIG. 98. In FIG. 96, in the relative positions shown the brake is not engaged. The external or outer permanent magnetic array is not shown for clarity. In FIG. 97, when engaged the stationary braking layer produces drag on the rotating components due to the eddy currents generated by the changing magnetic field through the conductive braking cylinder. The external or outer permanent magnetic array is not shown for clarity.

In an alternative embodiment, the braking cylinder could also be made from a material that is both ferromagnetic and electrically conductive. In this embodiment the braking effect would occur due to eddy current generation and hysteretic losses generated in the ferromagnetic material. The ferromagnetic material would also act as a magnetic shield between the two halves of coupling, thereby decreasing or removing the magnetic interaction between the two halves.

In yet a further variation the device can be constructed as purely an eddy current brake with a single internal or external flux directed permanent magnet cylinder and a conductive braking element. In this variant there is no torque transfer during normal operation—it simply acts as a brake when engaged.

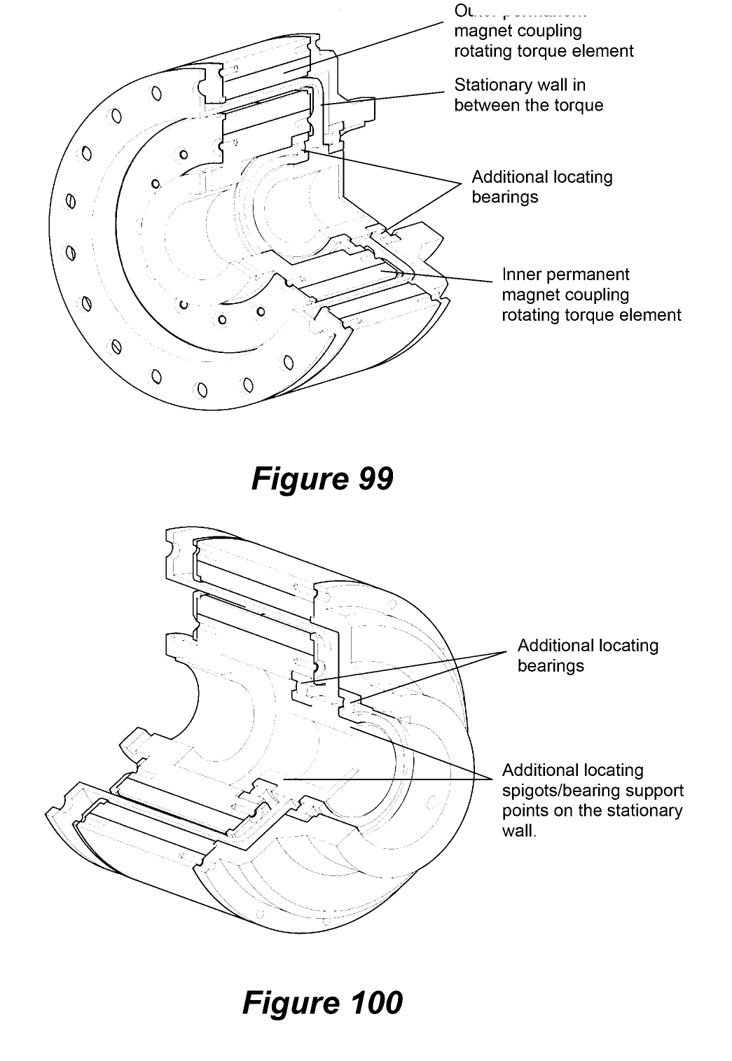

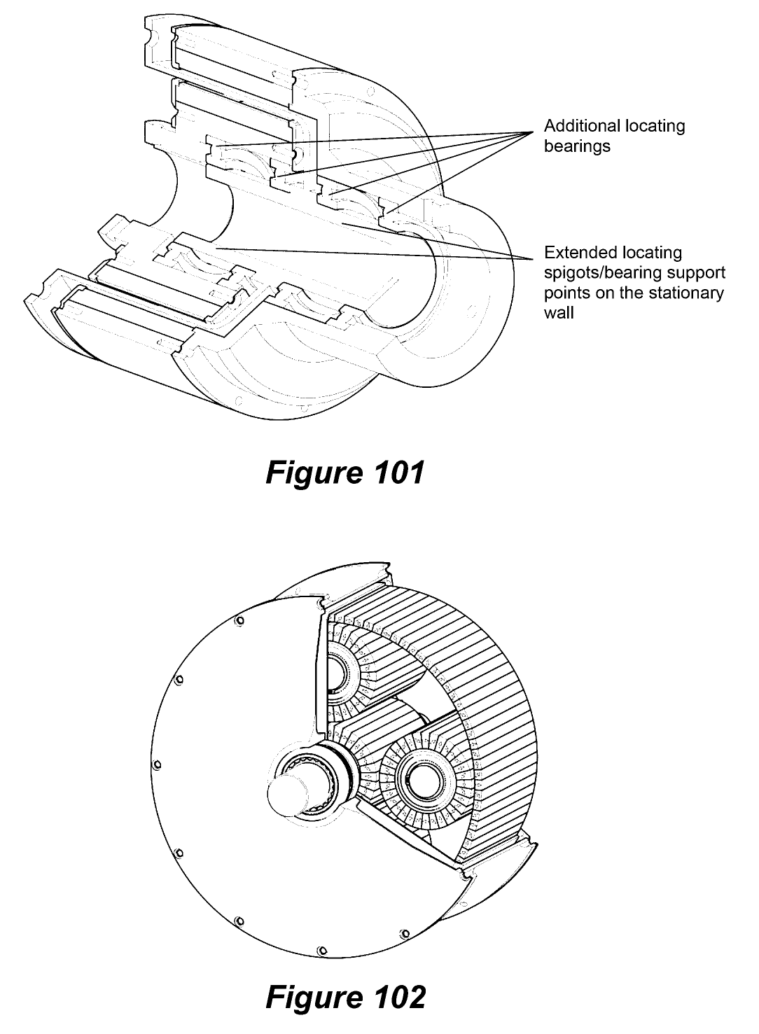

A further improvement to the flux directed magnetic coupling concerns the location and alignment of the two rotating torque elements of the magnetic coupling. Correct axial alignment of the inner and outer flux directed permanent magnet arrays is crucial to obtaining the best performance of the coupling in terms of torque output and vibration. In the embodiments shown in FIG. 99 and FIG. 100 additional locating bosses have been added either side of the end of the stationary wall that sits between the inner and outer halves of the coupling. Bearings are located on these bosses that also connect with corresponding bearing surfaces on the inner and outer magnet support structures. The support structure has additional stationary locating spigots and bearings at the end wall of the device to ensure correct and reliable alignment of the two rotating halves of the coupling. These bearings and bearing surfaces allow straightforward and repeatable alignment of the two rotating halves of the device. FIG. 101 shows a further variation where the locating bosses have been extended and a pair of bearings employed on either side of the end of the stationary wall.

### Epicyclical Magnetic Gearboxes:

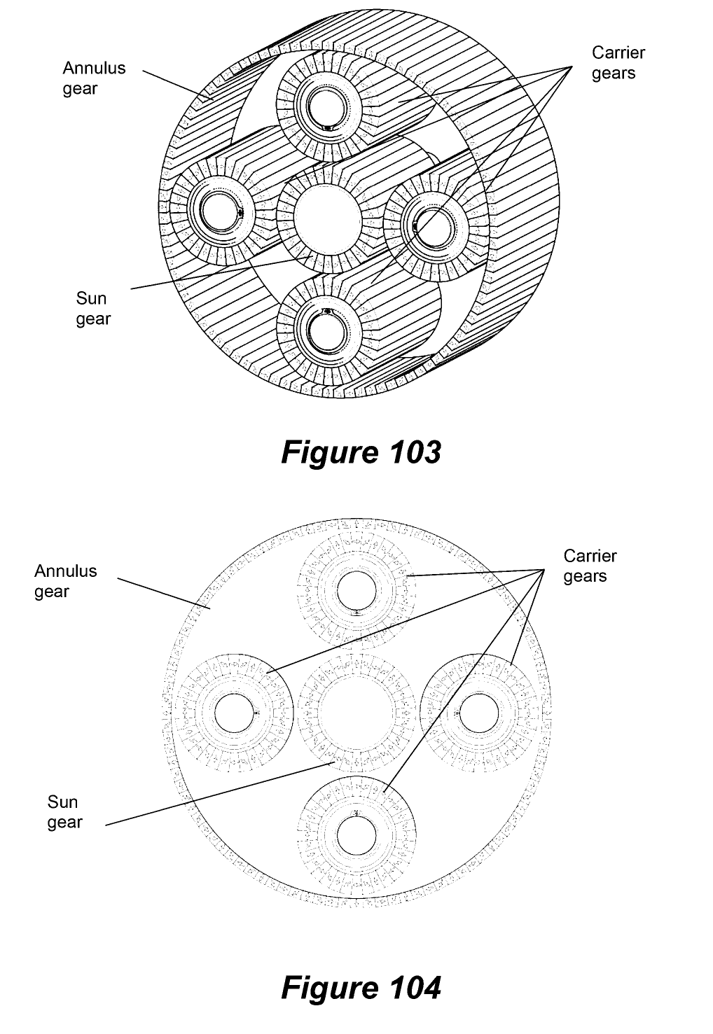

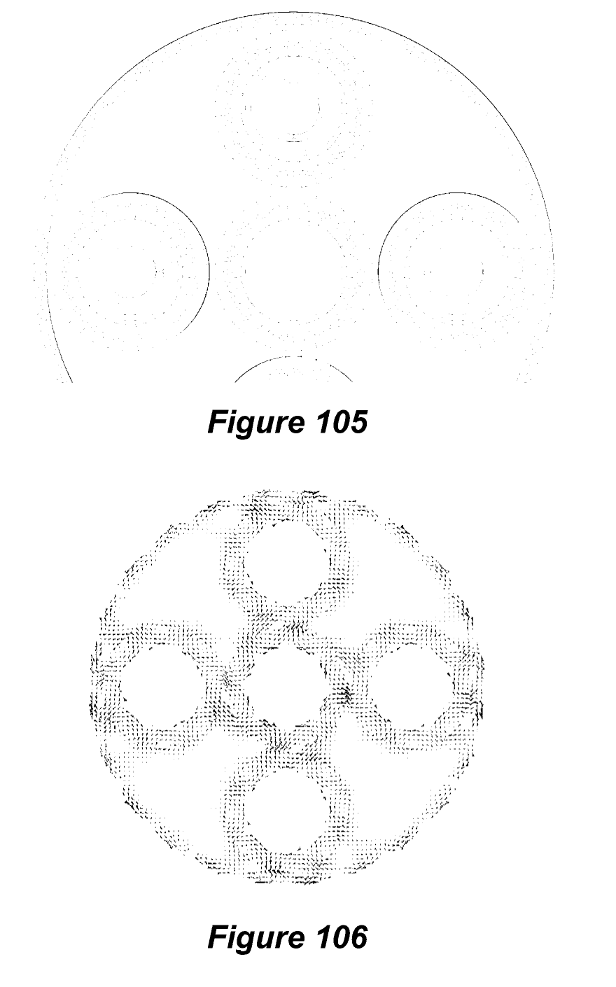

FIG. 102 through FIG. 106 show an embodiment of the previously disclosed epicyclical magnetic gearbox that is created from an externally magnetised Halbach cylinder, (sun gears), an internally magnetised Halbach cylinder (outer annulus gear) and a set of carrier gears made from externally magnetised Halbach cylinders. In the variation shown the central sun gear is an 8 Pole Halbach cylinder that has 4 discrete directions of magnetisation (or discrete magnetic elements) per pole. The sizes and pole counts of the other gear elements are readily determined by the gear ratio and primary pole count of the sun gear. As previously stated it would be obvious to a person skilled in the art that this number of discrete magnetic elements per pole could be readily increased or decreased.

### Motor and Gearbox Assembly for Advanced Vehicular Control:

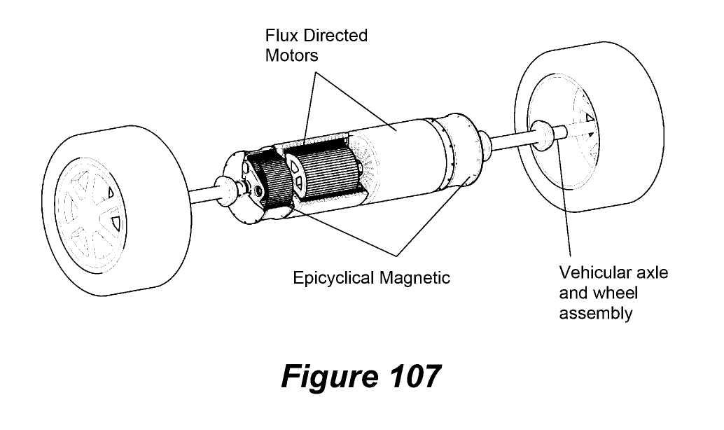

FIG. 107 shows an assembly that uses two separately controlled Flux Directed permanent magnet motors and epicyclical magnetic gearboxes shown in context with the axle of a vehicle. The independent control of the motors allows advanced vehicular control approaches to be used such as torque vectoring. This approach could replace the differential in an electric vehicle to allow for finer dynamic control of the speed and direction of the vehicle. This approach could be applied to any or all pairs of wheels in the vehicle.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1: An electromagnetic device comprising:
a stator;
a gap comprising multiple gap regions; and
a rotor arranged in the gap to move relative to the stator,
wherein:
one of the stator and the rotor comprises a conductor array having one or more conductors each configured to carry current in a respective current flow direction,
the other of the stator and the rotor comprises a flux directing assembly having multiple flux directing sections, each flux directing section including one or more electromagnetic coils and arranged adjacent to at least one other flux directing section, and each flux directing section configured to contain magnetic field to follow a circulating magnetic flux path defined by the one or more electromagnetic coils about the respective flux directing section, and
each pair of adjacent flux directing sections are arranged about a common gap region of the multiple gap regions and configured to direct at least part of the respective circulating magnetic flux paths across the common gap region in a substantially similar flux direction substantially perpendicular to the current flow direction.

2: The electromagnetic device of claim 1, wherein the adjacent flux directing sections comprise a common working element configured to direct magnetic flux into and out of the common gap region.

3: The electromagnetic device of claim 1, wherein the adjacent flux directing sections are further configured to redirect the respective circulating magnetic flux paths from (or to) other gap regions of the multiple gap regions to (or from) the common gap region.

4: The electromagnetic device of claim 3, wherein each of the adjacent flux directing sections comprises a redirecting element configured to receive (or forward) the magnetic flux from (or to) the common gap region and redirect the magnetic flux to (or from) a respective one of the other gap regions.

5: The electromagnetic device of claim 4, wherein strength of the magnetic flux directed by the common working element is reinforced compared to strength of the magnetic flux directed by the redirecting element.

6: The electromagnetic device of claim 2, wherein the common working element comprises two electromagnetic coils placed on opposite sides of the common gap region.

7: The electromagnetic device of claim 4, wherein the redirecting element comprises a single electromagnetic coil configured to direct the magnetic flux through the single electromagnetic coil in a direction tangential to the rotation of the rotor.

8: The electromagnetic device of claim 4, wherein the redirecting element comprises two electromagnetic coils, each placed on an opposite side of the gap.

9: The electromagnetic device of claim 7, wherein the redirecting element comprises one or more additional electromagnetic coils configured to direct the magnetic flux to (or from) the single electromagnetic coil.

10: The electromagnetic device of claim 6, wherein the opposite sides of the gap or the common gap region represent an inner portion and an outer portion of the flux directing assembly, the inner portion comprising a flux guide and the outer portion comprising one or more electromagnetic coils.

11: The electromagnetic device of claim 6, wherein the opposite sides of the gap or the common gap region represent an inner portion and an outer portion of the flux directing assembly, the inner portion comprising one or more electromagnetic coils and the outer portion comprising a flux guide.

12: The electromagnetic device of claim 6, wherein the electromagnetic coil(s) comprise one or more racetrack coils.

13: The electromagnetic device of claim 2, wherein the redirecting element comprises one or more permanent magnets placed on each of the opposite sides of the common gap region and oriented in a substantially non-radial direction.

14: The electromagnetic device of claim 1, wherein the redirecting element comprises (a) a flux guide on the first side of the common gap region and (b) one or more permanent magnets placed on the second, opposite side of the common gap region and oriented in a substantially non-radial direction.

15: The electromagnetic device of claim 13, wherein the permanent magnets are oriented to form one or more Halbach arrays or partial Halbach arrays.

16: The electromagnetic device of claim 1, wherein the respective circulating magnetic flux paths of the adjacent flux directing sections circulate in opposite directions.

17: The electromagnetic device of claim 16, wherein the circulating magnetic flux path of one of the adjacent flux directing sections is in a clockwise direction and the circulating magnetic flux path of the other of the adjacent flux directing sections is in an anticlockwise direction.

18: The electromagnetic device of claim 1, wherein the number of the circulating magnetic flux paths equals the number of magnetic flux traversals across the gap.

19: The electromagnetic device of claim 18, wherein the number of flux directing sections equals the number of gap regions.

20-21. (canceled)
